(19) United States
(12) Patent Application Publication
(10) Pub. No.: US 2026/0275234 A1
(43) Pub. Date: Sep. 17, 2026

(54) OPTIMIZING THE FLOW CHARACTERISTICS OF LIQUID CLEANING COMPOSITIONS

(71) Applicant: Reckitt & Colman (Overseas) Hygiene Home Limited, Slough, Berkshire (GB)

(72) Inventors: Jyoti CHOUDHARY, Haryana (IN); SKand SAKSENA, Montvale, NJ (US); Ramneek SINGH, Montvale, NJ (US); Sarang WAGHANNA, Haryana (IN)

(21) Appl. No.: 19/472,209

(22) PCT Filed: Apr. 10, 2024
(86) PCT No.: PCT/EP2024/059744

§ 371 Date: Oct. 3, 2025

(30) Foreign Application Priority Data
Apr. 10, 2023 (IN) 202341026618
May 23, 2023 (GB) 2307688.8

(51) Int. Cl. C11D 1/75; C11D 1/62; C11D 1/835; C11D 3/00; C11D 3/04; C11D 3/20; C11D 3/37; C11D 3/40; C11D 3/50

(52) U.S. Cl. CPC C11D 1/75; C11D 1/62; C11D 1/835; C11D 3/0047; C11D 3/0084; C11D 3/042; C11D 3/2034; C11D 3/3707; C11D 3/40; C11D 3/50; C11D 2111/24

(57) ABSTRACT

The present invention describes a hard surface cleaning composition comprising at least one acidic source in an amount ranging between 4% to 20% weight and at least one superwetting agent in amount ranging between 0.001 to 5% weight, wherein the composition is adapted to provide a contact angle ranging between 5 to 30 degrees when it is applied on hard flat surfaces.

### FIELD OF INVENTION

The present invention relates generally to viscous liquid toilet bowl and lavatory compositions for cleaning hard surfaces, the composition having an acidic component, a surfactant system and at least one superwetting agent. The present invention is also directed to the methods of use and manufacturing the same.

### BACKGROUND

To achieve effective cleaning of lavatory appliances, a cleaning composition must provide an effective coverage of the surfaces intended to be cleaned for an amount of time that is sufficient for the cleaning composition to stay in contact with the stains on the surfaces of the lavatory appliances. To that end, the key consumer likeability and performance indicator appears to be the viscosity of such cleaning compositions as high viscosity formulations provide the longest contact time with the stains of interest.

There are many hard surface cleaning compositions described in the art for use against variety of stains and organic soils deposits typically observed in lavatories and bathrooms, e.g., limescale stains, soap scum. These compositions are sold in squeezable bottles which can dispense a uniform quantity of a cleaning composition to the interior of a toilet bowl once the bottle containing such a composition are squeezed, allowing the expelling of its contents out from a nozzle. While it is advantageous to utilize a liquid composition which is viscous in order to provide good coverage and retention on an inclined surface, e.g., the interior of a toilet bowl, obtaining the appropriate viscosity and at the same time achieving the necessary contact angle when on a hard surface and dispensing of such compositions from a squeeze bottle have not been without problems and unique challenges.

For example, upon administration of a viscous composition in an inclined surface, it is almost universally observed that as the layer, or lamina of applied liquid slowly descends towards the bottom of the interior of the toilet bowl, the lamina almost always separates into a plurality of discrete downwardly extending regions of the cleaning composition, referred to as “fingers,” defining the extent of coverage by the cleaning compositions. These fingers are the zones or regions of the interior surfaces of the toilet bowl covered by the cleaning compositions while traveling down to the bottom part of the toilet bowls. However, they are also interspersed with zones or regions that are not covered by the cleaning composition and stay uncoated despite the cleaning compositions traveling down the toilet's internal surface.

As such the available viscous cleaning compositions typically fail to provide a complete surface coverage within the internal surface of the toilet bowl. To maximize coverage, the user must either reapply the composition with additional amount of the cleaning composition or the user has to manually intervene by using a toilet brush and physically spread the cleaning composition to the uncoated zones or regions. These alternatives not only fail to provide a sustainable solution, but also lead to waste of material and consumer's time.

While U.S. Pat. No. 7,745,384 described cleaning composition that provided improved surface coverage when applied from a squeeze bottle container onto an inclined hard surface, the compositions described therein, are low in viscosity leading to lower contact time with the stained surface thereby requiring the user to manually intervene or apply more of the composition to the uncovered zones or regions. Thus, there is a need to provide stronger hard surface cleaners with sufficient higher viscosity and better flow profile that can maximize surface coverage, cleaning and disinfection without using a toilet brush or reapplication of the cleaner composition.

### SUMMARY OF THE INVENTION

The present invention overcomes the shortcomings of the prior art by providing viscous toilet cleaner compositions that when applied to an inclined surface, forms a uniform layer having an unique flow profile that provide at least 60%, 65%, 70%, preferably 80%, most preferably 90%, coverage of the toilet bowl's internal surface. The uniform layer formed on the inclined surface of a toilet bowl is facilitated by the composition's ability to form a contact angle ranging between 5 to 25 degrees when the toilet cleaning composition according to the present invention is applied to a hard ceramic/porcelain surface.

In a first aspect of the invention, a hard surface cleaning composition for treatment of a sanitary appliance is described containing (a) at least one acidic source and (b) at least one superwetting agent, wherein the composition has a viscosity ranging between about 1000 cP to 3000 cP, preferably between about 1500 cP to 2500 cP, and more preferably between about 1900 cP to 2100 cP as measured by Brookfield Viscometer RVDV-II, Spindle No. 3, at 20 rpm, at 20° C., and the weight ratio between the acid source and the superwetting agent is about 5 to 200, and wherein the composition provides a contact angle ranging between about 5 to 30 degrees on the hard flat surface laid out horizontally.

In one embodiment of the invention, a hard surface cleaning composition for treatment of a sanitary appliance is described containing (a) least one acidic source in an amount ranging between about 4% to 20% weight, (b) at least one superwetting agent selected from the group consisting of trisiloxane surfactants, gemini surfactants, ethoxylated trisiloxanes, silicone glycol copolymers, pegylated dimethicones, N-alkyl pyrrolidones, non-ionic fluorosurfactants, polyether polyols, primary alcohol ethoxylates, alkylamine oxide, and secondary ethoxylated alcohols, wherein the composition has a viscosity ranging between about 1000 cP to 3000 cP, preferably between about 1500 cP to 2500 cP, and more preferably between about 1900 cP to 2100 cP, as measured by Brookfield Viscometer RVDV-II, Spindle No. 3, at 20 rpm, at 20° C., and the weight ratio between the acid source and the superwetting agent is about 5 to 200, and wherein the composition provides a contact angle ranging between 5 to 30 degrees on the hard flat surface laid out horizontally. In some embodiments, the primary alcohol ethoxylates is lauryl alcohol 9-ethoxylates. In some embodiments, the alkylamine oxide is lauryl amine oxide. In some embodiments, the superwetter agent is a combination of lauryl alcohol 9-ethoxylates and lauryl amine oxide.

In one embodiment, the present invention is directed to a hard surface cleaning composition for treatment of a sanitary appliance such as a toilet bowl or an urinal, comprising (a) at least one acidic source in an amount ranging between about 4% to 20% weight, (b) a surfactant system, (c) at least one superwetting agent selected from the group consisting of trisiloxane surfactants, gemini surfactants, ethoxylated trisiloxanes, silicone glycol copolymers, pegylated dimethicones, N-alkyl pyrrolidones, a fluorosurfactants, polyether polyols, primary alcohol ethoxylates, alkylamine oxide, and secondary ethoxylated alcohols. The composition has a viscosity ranging between about 1000 cP to 3000 cP, preferably between about 1500 cP to 2500 cP, and more preferably between about 1900 cP to 2100 cP, at 20° C. as measured with Brookfield Viscometer Brookfield RVDV-II, Spindle No. 3, at 20 rpm and the ratio between the acid source and the superwetting agent is 5 to 200 respectively, and wherein the composition provides a contact angle ranging between 5 to 30 degrees on the hard flat surface laid out horizontally. In some embodiments, the composition according to the first aspect of the invention has a pH less than 5, preferably less than 4. In some embodiments, the superwetting agent is present in concentrations ranging between about 0.001 wt. % and about 5 wt. %, preferably ranging between 0.01 wt. % and 3.5 wt. %, and more preferably between about 0.1 wt. % and about 3 wt. %. In some embodiments, the primary alcohol ethoxylates is lauryl alcohol 9-ethoxylates. In some embodiments, the alkylamine oxide is lauryl amine oxide. In some embodiments, the superwetter agent is a combination of lauryl alcohol 9-ethoxylates and lauryl amine oxide.

In some embodiments, the acid source of the composition according to the first aspect of the invention is an organic or an inorganic acid, wherein: (a) the organic acid is selected from the group consisting of: (i) linear aliphatic acids, preferably selected from the group consisting of formic acid, acetic acid, propionic acid, butyric acid and valeric acid; (ii) dicarboxylic acids, preferably selected from the group consisting of oxalic acid, malonic acid, succinic acid, glutaric acid, adipic acid, pimelic acid, fumaric acid and maleic acid; (iii) acidic amino acids, preferably selected from the group consisting of glutamic acid and aspartic acid; and (iv) hydroxy acids, preferably selected from the group consisting of glycolic acid, lactic acid, hydroxyacrylic acid, alpha-hydroxybutyric acid, glyceric acid, tartronic acid, malic acid, tartaric acid and citric acid, (v) the acid salts thereof; and any combinations thereof; and/or (b) the inorganic acid is selected from the group consisting of hydrochloric acid, sulfuric acid, phosphoric acid, potassium dihydrogenphosphate, sodium dihydrogenphosphate, sodium sulfite, potassium sulfite, sodium pyrosulfite (sodium metabisulfite), potassium pyrosulfite (potassium metabisulfite), acid sodium hexametaphosphate, acid potassium hexametaphosphate, acid sodium pyrophosphate, acid potassium pyrophosphate, sulfamic acid, and salts thereof, and any combinations thereof, preferably hydrochloric acid sulfuric acid.

In other embodiments, the composition according to the first aspect of the present invention further contains a dye, a fragrance, an anti-oxidant, a biocide, a solvent, a thickener, a film forming polymer or any mixture thereof.

In some embodiments, the compositions according to the present invention provides surface area coverage on a toilet bowl of at least of less 65% with a dispensed product volume of at least 30 ml but not more than 50 ml when the product is applied uniformly under the rim around the top periphery of the bowl.

In the second aspect, the present invention is directed to a method of cleaning a hard surface of a sanitary appliance, such as a toilet bowl comprising (a) contacting the surface with the hard surface cleaning composition according to the first aspect of the invention, (b) achieving at least 65% surface coverage of the toilet bowl with a dispensed product volume at least 30 ml, or 40 ml but not more than 50 ml when the product is applied uniformly under the rim around the top periphery of the bowl, (c) allowing at least 1 minute of contact time, but no longer than 15 minutes with the hard surface, and (d) applying water to rinse the hard surface, wherein the method removes at least 75% of all stains without the use of a brush.

In the third aspect, the present invention is directed to a method of identifying a suitable superwetter for use in a hard surface cleaning composition comprising the steps of (a) choosing a hard surface cleaning composition having a viscosity of at least 1000 cP as measured by Brookfield Viscometer RVDV-II, Spindle No. 3, at 20 rpm, at 20° C., (b) applying the cleaning composition to a hard surface, (c) measuring the contact angle between the cleaning composition and the hard surface, (d) adding a candidate superwetter to said cleaning composition, (e) repeating steps (a)-(d), wherein the candidate superwetter ingredient achieves at least a 20% reduction in contact angle of step (c), preferably wherein the contact angle is in the range of 5° to about 25°.

In some embodiments, according to the third aspect of the present invention, the reduction in contact angle is by 20%, 30%, 40%, preferably 50%. It will be understood that by adding a superwetter to a cleaning composition the contact angle between the cleaning composition and the hard surface is reduced, compared to a cleaning composition devoid of said superwetter.

In the fourth aspect, the present invention is directed to a method of increasing surface coverage of a hard surface cleaning composition in an inclined toilet bowl comprising the steps of (a) choosing a hard surface cleaning composition having a viscosity of at least 1000 cP as measured by Brookfield Viscometer RVDV-II, Spindle No. 3, at 20 rpm, 20° C., (b) applying the cleaning composition to a hard surface, (c) adding a candidate superwetter to said cleaning composition, (d) repeating steps (a)-(c) wherein the candidate superwetter achieves at least a 15% increase in the surface coverage compared to that of step (b).

It will be understood that by adding a superwetter to a cleaning composition the surface coverage of a cleaning composition in an inclined toilet bowl is increased, compared to a cleaning composition devoid of said superwetter.

In some embodiments, the use of the cleaning composition according to the present invention provides a 20% increase in the covered surface area as compared to any other compositions described in the art. In other embodiments, the cleaning performance of the compositions according to the first aspect of the present invention achieves a reduction of at least 50% of all stains existed pre application of the composition to the bowl. In preferred embodiments, the hard surface is ceramic or porcelain.

### DESCRIPTION OF THE DRAWING

FIG. 1, A1-F2, provides depictions of the degree of cleaning and surface coverage of the compositions according to the present invention as compared to those of prior art.

FIG. 2, provides a depiction of the geometric meaning of the term “contact angle.”

FIG. 3 provides a summary of the contact angle measurements for the compositions according to the present invention.

### DETAILED DESCRIPTION OF THE INVENTION

The disclosure relates to the viscous liquid hard surface cleaning compositions and methods of using such compositions to remove stains, soil or oil deposits in inclined hard surfaces and methods of using the same.

### Definitions

To facilitate understanding of the disclosure set forth herein, a number of terms are defined below. Unless defined otherwise, all technical and scientific terms used herein have the same meaning as is commonly understood by one of skill in the art to which this invention belongs and shall be understood to have the meanings described below. All publications and patents referred to herein are incorporated by reference in their entirety. Unless otherwise specified, a reference to a particular compound includes all ionic, salt, solvate, protected forms, and other stereoisomers thereof, isomeric forms, including racemic and other mixtures thereof.

As used herein, “about” will mean up to plus or minus 1% of the respective term.

As used herein, “consisting essentially of” refers to the combination of ingredients listed in the claim and excludes addition of any active ingredients to the combination. It also excludes addition of any excipient that materially affect the basic and novel properties of the composition.

The term “effective amount” as used herein, pertains to that amount of an active compound, or a material, composition, or dosage according to the present invention which is effective for producing the desired cleaning and/or disinfecting effects including germicidal and reduction of bacterial load and/or the microorganism cell count.

The term “hard surface” is meant to include all variations of hard surface areas including but not limited to areas that are made of such material as bricks, ceramic, cement, crystal, diamond, glass, latex, marble, metallic, pebbles, porcelain, polymeric and quarry tiles, and natural stone. An “inclined hard surface” refers to hard surfaces having at least 15° inclination as opposed to the same in a flat position.

The term “sanitary appliance” generally refers to toilet bowl, urinal, fixtures and similar objects in lavatory.

The term “surfactant system” refers to a single or combination of surfactant(s) selected from any such category of surfactants such as non-ionic, anionic, cationic, and amphoteric surfactants.

The term “superwetting agent(s)” or “superwetter(s)” as used interchangeably herein refers to any single or combinations of wetting agents which are highly efficient at reducing surface tension, facilitating the forming of a contact angle between a cleaning composition and a hard surface within the ranges of 0 to 30°, preferably within the ranges of 2 to 27.5°. In some forms the superwetters are able to reduce the contact angle of a cleaning composition by at least 25% as compared to the same composition without any such superwetters.

By the term “substantially free,” is meant that the final product contains less than 0.5% weight of the identified ingredient, while by the term “free,” it is meant that the final product is free of any traces of the identified ingredient to the extent that it could be detected by general quantitative assays known in the art for detection of such ingredient in the final product or if detected, it is in residual content of the ingredient and in principle only attributable to impurities.

The term “treatment” as used herein in the context of applying or treating the desired surface to the extent that positive benefits are observed.

As used herein the term “uniform” or “uniformly” refers to the application of the fluid composition according to the present invention in such manner that when the composition descends towards the bottom of an inclined hard surface it flows into different parts of the hard surface with equal flow velocity per unit area so that it would minimize the appearance of discrete regions or zones created from the downward flow of the cleaning composition, referred to as “fingers.”

In some aspects, the present invention is directed to hard surface cleaning compositions comprising a least one acidic source in an amount ranging between about 1% to 50% weight, preferably between about 2% to 25% weight, more preferably between about 4% to 20% weight, optionally at least one surfactant or a surfactant system, and at least one superwetting agent, wherein the cleaning composition has a viscosity ranging between about 1000 cP to 3000 cP, preferably between about 1500 cP to 2500 cP, and more preferably between about 1900 cP to 2100 cP as measured by Brookfield Viscometer RVDV-II, Spindle No. 3, at 20 rpm, at 20° C., and the weight ratio between the acid source and the superwetting agent is 5 to 200 parts acid respectively. The cleaning composition according to this aspect of the invention, provides a contact angle ranging between 5 to 30 degrees (O is about 5 to 30 degrees) when applied to the hard surface in a flat position. In some embodiments, the amount of superwetting agents in the cleaning composition is less than 3.0% by total weight of the composition.

The superwetting agent is selected from the group consisting of a trisiloxane surfactants, gemini surfactants, ethoxylated trisiloxanes, silicon glycol copolymers, pegylated dimethicones, N-alkyl pyrrolidones such as N-Octyl-2-pyrrolidone or N-dodecyl-2-pyrrolidone, fluorosurfactants, polyether polyols, primary alcohol ethoxylates, alkylamine oxide and a secondary ethoxylated alcohols. In some embodiments, the weight ratio of the acid source to the super wetting agent ranges between 20 parts acid to 1 part if the superwetter is a fluorosurfactant. In some embodiments, the primary alcohol ethoxylates is lauryl alcohol 9-ethoxylates. In some embodiments, the alkylamine oxide is lauryl amine oxide. In some embodiments, the superwetter agent is a combination of lauryl alcohol 9-ethoxylates and lauryl amine oxide.

In other aspects, the present invention describes cleaning compositions that can remove stains reduce the bacterial load and/or microorganism cell counts by at least 2, 3 or preferably 4 to 5 logarithmic scale, on hard surfaces of a sanitary appliance, as compared to the population of the same bacteria or microorganisms that might have existed on the surfaces before applying the instantly described compositions. In some embodiment, the inventors have surprisingly identified unique combinations of surfactants comprising at least one cationic surfactant, and at least one super wetting agent selected from the group consisting of trisiloxane surfactants, gemini surfactants, ethoxylated trisiloxanes, silicon glycol copolymers, pegylated dimethicones, N-Octyl-2-pyrrolidone, N-dodecyl-2-pyrrolidone, fluorosurfactants, polyether polyols, primary alcohol ethoxylates, alkylamine oxide and secondary ethoxylated alcohols that can effectively disinfect and clean a hard surface area while providing a broad germicidal activity against organisms selected from the group consisting of Enterococcus hirae, Escherichia Coli, Staphylococcus aureus and Pseudomonas aeruginosa and various viruses as well such as Rotavirus, RSV, Norovirus, SARS COVID.

In some embodiments, the amount of superwetting agents in the cleaning composition is less than 3.0% by total weight of the composition. In some embodiments, the primary alcohol ethoxylates is lauryl alcohol 9-ethoxylates. In some embodiments, the alkylamine oxide is lauryl amine oxide. In some embodiments, the superwetter agent is a combination of lauryl alcohol 9-ethoxylates and lauryl amine oxide. In certain embodiments, such combination of ingredients is substantially free of any bleaching agent. In certain embodiments, such combination of ingredients is substantially free of any anionic surfactants. In certain embodiments, the combination further includes a colorant and a fragrance. In certain embodiments, the unique combinations according to the present invention is free of any bleaching agent and any anionic surfactants.

In other aspects, methods of cleaning and/or disinfecting a sanitary appliance such as a toilet bowl surface comprising the steps of applying a cleaning composition according to the present invention to an inclined hard surface and rinsing the same treated area with water, wherein the cleaning composition has at least one acidic source in an amount ranging between about 4% to 20% by total weight of the composition, a surfactant system comprising at least one non-ionic and one cationic surfactant, and at least one superwetter selected from the group consisting of a trisiloxane surfactants, gemini surfactants, ethoxylated trisiloxanes, silicon glycol copolymers, peglyated dimethicones, N-octyl-2-pyrrolidone, N-dodecyl-2-pyrrolidone, fluorosurfactants, polyether polyols, primary alcohol ethoxylates, alkylamine oxide, and a secondary ethoxylated alcohols, with the proviso that when a fluorosurfactant is used as a superwetting agent, the viscosity of the composition is at least about 1900 cPs up to 2300 cPs at 20° C., and the weight ratio of the acid component to the super wetting agent ranges between 5 to 200.

In some embodiments, the primary alcohol ethoxylates is lauryl alcohol 9-ethoxylates. In some embodiments, the alkylamine oxide is lauryl amine oxide. In some embodiments, the superwetter agent is a combination of lauryl alcohol 9-ethoxylates and lauryl amine oxide. In preferred embodiments according to this aspect of the invention, the method further comprises the step of achieving at least 60%, 65%, preferably more than 70%, most preferably more than 80% coverage of the toilet bowl surface without the use of any toilet brush.

In some embodiments, the composition of the present invention is able to achieve a degree of germ kill allowing sufficient time and coverage for the composition to come in direct contact with the hard surfaces of interest, achieving at least a twofold reduction of the bacterial load (number of bacterial cells) of at least any three species of Enterococcus hirae, Escherichia Coli, Staphylococcus aureus and Pseudomonas aeruginosa. In some embodiments, the compositions of the present invention achieve a 4-log reduction of the bacterial load of all such species. In some embodiments, the compositions of the present invention achieve a 5-log reduction of the bacterial load of all such species.

In other aspects, the present invention is directed to methods of identifying a surfactant system and at least one superwetting agent that reduces the contact angle of acid-based toilet bowl cleaning compositions thereby achieving maximum coverage on toilet bowl internal surfaces. To that end, the inventors have explored multiple classes of superwetters and have identified a limited number of chemical ingredients and combination of surfactants that are able to achieve more than 80% surface area coverage of inclined surfaces, by achieving a contact angle between the surface and the cleaning composition of about 5 to 30°, while maintaining a viscosity of about 1000 to 3000 cP, preferably between about 1500 to 2500 cP, and more preferably between about 1900 cP and 2100 cP at 20° C. as measured by Brookfield Viscometer RVDV-II, Spindle No. 3, at 20 rpm, at 20° C.

In some embodiments according to this aspect, the present invention is directed to methods of exploring cleaning compositions for hard surface areas that have suitable flow properties and viscosity for removal of soil and other residues. In preferred embodiments, the cleaning compositions according to the present invention are able to provide a contact angle ranging between about 5° to about 30°, preferably between 10° to 25°, thereby reducing the need to reapply the cleaning composition to cover all surfaces of interest and reduce the need for manual intervention such as using a brush by the consumers. While contact angle can be specific to the type of surface and the compositions, at least one aspect of the present invention is directed to providing cleaning compositions that provide surface contact angles of less than about 30°, 27°, 25°, 15°, or 10° after the composition is applied to a flat surface. In some embodiments, the flat surface is of ceramic or porcelain material.

In some embodiments, the present invention is directed to a method of identifying suitable superwetting agents to be used in a cleaning composition for hard surfaces, particularly lavatory appliances and especially such surfaces and appliance surfaces which are vertical or inclined following the steps of applying the compositions of the present invention, achieving an uniform fluid down flow with a contact angle ranging between about 10° to about 30° while achieving at least 60%, 65%, 70%, preferably more than 70%, most preferably more than 80% coverage of the total surface area treated.

Details of different aspects according to the present invention is further elaborated below.

### Compositions

The cleaning composition according to the present invention has at least one acidic source in an amount ranging between about 4% to 20% weight, at least one superwetting agent selected from the group consisting of trisiloxane surfactants, gemini surfactants, ethoxylated trisiloxanes, silicon glycol copolymers, pegylated dimethicones, N-alkyl pyrrolidones (e.g. N-Octyl-2-Pyrrolidone, N-Dodecyl-2-Pyrrolidone), fluorosurfactants, polyether polyols, primary alcohol ethoxylates, alkylamine oxide and secondary ethoxylated alcohols, wherein the viscosity of the composition is at least about 1000 cP up to about 3000 cP, preferably between about 1500 cP to 2500 cP, and more preferably between about 1900 cP to 2100 cP as measured by Brookfield Viscometer RVDV-II, Spindle No. 3, at 20 rpm, at 20° C. and the weight ratio of the acid source to the superwetting agent ranges between 5 to 200, and preferably 10 parts acid to 1 part if a fluorosurfactant superwetting agent is used. In some embodiments, the primary alcohol ethoxylates is lauryl alcohol 9-ethoxylates. In some embodiments, the alkylamine oxide is lauryl amine oxide. In some embodiments, the superwetter agent is a combination of lauryl alcohol 9-ethoxylates and lauryl amine oxide. In some embodiments, the amount of superwetting agents in the cleaning composition is less than 3.0%, in some embodiments, less than 2% by total weight of the composition. The composition according to this aspect of the invention, provides a contact angle ranging between 5° to 30° on the hard flat surface horizontally positioned, preferably from 10° to 25°; the hard surface is preferably a hard ceramic surface.

In some embodiments, the composition according to the present invention, provides at least 60%, 65%, 70%, preferably more than 80% surface area coverage of the toilet bowl inside wall when a volume ranging between 30 ml to 50 ml, preferably less than 40 ml, is applied to rim under the toilet bowl or the surface area of interest. In some embodiments, the composition according to the present invention may be left on the toilet bowl surface a period ranging between 3 to about 6 minutes, preferably less than 4 minutes, most preferably less than 3 minutes.

### Acidic Source

The cleaning composition according to the present invention have a viscosity ranging between about 1000 cP to 3000 cP, preferably between about 1500 cP to about 2500 cP, and more preferably between about 1900 cP to 2100 cP, which can exhibit a pH of about 5 or less. In some embodiments, the compositions contain at least one inorganic and/or one organic acid in sufficient amounts to have a pH of 4 or less, preferably a pH of 3.8, 3.5, 3.25, 3.0, 2.75, 2.5, 2.25, 2, 1.75, 1.5, 1.25, 1, 0.9, 0.8, 0.7, 0.6, 0.5, 0.4, 0.3, 0.2, and 0.1 or lower.

Exemplary acids include an organic or an inorganic acid, wherein preferably: (a) the organic acid is selected from the group consisting of: (i) linear aliphatic acids, preferably selected from the group consisting of formic acid, acetic acid, propionic acid, butyric acid and valeric acid; (ii) dicarboxylic acids, preferably selected from the group consisting of oxalic acid, malonic acid, succinic acid, glutaric acid, adipic acid, pimelic acid, fumaric acid and maleic acid; (iii) acidic amino acids, preferably selected from the group consisting of glutamic acid and aspartic acid; and (iv) hydroxy acids, preferably selected from the group consisting of glycolic acid, lactic acid, hydroxyacrylic acid, alpha-hydroxybutyric acid, glyceric acid, tartronic acid, malic acid, tartaric acid and citric acid, (v) the acid salts thereof; and any combinations thereof; and/or (b) the inorganic acid is selected from the group consisting of hydrochloric acid, sulfuric acid, phosphoric acid, potassium dihydrogenphosphate, sodium dihydrogenphosphate, sodium sulfite, potassium sulfite, sodium pyrosulfite (sodium metabisulfite), potassium pyrosulfite (potassium metabisulfite), acid sodium hexametaphosphate, acid potassium hexametaphosphate, acid sodium pyrophosphate, acid potassium pyrophosphate, sulfamic acid, and salts thereof, and any combinations thereof, preferably hydrochloric acid sulfuric acid.

In more preferred embodiments, the acid source is selected from the group consisting of hydrochloric acid, sulfuric acid, phosphoric acid, sulfamic acid, formic acid, acetic acid, propionic acid, butyric acid, oxalic acid, fumaric acid, maleic acid; glycolic acid, hydroxyacrylic acid, alpha-hydroxybutyric acid, glyceric acid, tartronic acid, tartaric acid and citric acid, and salts thereof. These acids can be used singly or as a mixture of two or more. Of these acids, hydrochloric acid, sulfamic acid, citric acid, formic acid, oxalic acid, and fumaric acid are particularly preferred for use as the sole acid source. Of lesser preference mixtures comprising any combination of such acids are also included.

While the acids may be present in any effective amount in order to attain a desired acidic pH, they are present in an amount of from about 2% to 25% weight and but preferably from about 4% to 20% weight, based on the total weight of the compositions of which they form a part. In certain preferred embodiments of the invention the sole acids present are one or more of hydrochloric acid, citric acid, formic acid, oxalic acid, and fumaric acid, and salts thereof.

### Surfactants

Aside from any superwetters, the compositions of the invention can include at least one surfactant system. Such surfactant system may include at least one or more surfactants to be selected from nonionic, cationic, amphoteric as well zwitterionic surfactants. In a preferred embodiment, the surfactant system of the compositions of the present invention includes at least one non-ionic surfactant and one cationic surfactant. In certain embodiments, the composition is substantially free of any anionic surfactants. In certain embodiments, the composition is free of any anionic surfactants. Those of skilled in the art would appreciate that surfactant system and the superwetting agent source are two different components and would not replace their own intended purpose within the compositions according to the resent invention.

In at least one embodiment, the surfactant system is present in the inventive compositions of the present invention, generally in an amount of at least 0.01% wt. to 35% wt., and preferably the total amount of surfactants present in the inventive compositions does not exceed about 25% wt., more preferably does not exceed about 15% wt., and most preferably does not exceed 10%. In some embodiments, the amount of the surfactant system present is from 0.5% wt. to 7.5% wt., more preferably from 0.75% wt. to 5% wt.

Non-ionic surfactants that may be used in the present invention include the following: polyalkylene oxide condensates of alkyl phenols. These compounds include the condensation products of alkyl phenols having an allyl group containing from about 6 to 20, preferably 6 to 12 carbon atoms in either a straight chain or branched chain configuration with an alkylene oxide, especially an ethylene oxide, the ethylene oxide being present in an amount equal to 5 to 35 moles of ethylene oxide per mole of alkyl phenol. The alkyl substituent in such compounds can be derived, for example, from polymerized propylene, diisobutylene and the like. Examples of compounds of this type include nonyl phenol condensed with about 9.5 moles of ethylene oxide per mole of nonyl phenol; dodecylphenol condensed with about 12 moles of ethylene oxide per mole of phenol; dinonyl phenol condensed with about 15 moles of ethylene oxide per mole of phenol and diisooctyl phenol condensed with about 15 moles of ethylene oxide per mole of phenol.

A further class of useful nonionic surfactants include the condensation products of aliphatic alcohols with from about 1 to about 60 moles of an alkylene oxide, especially an ethylene oxide. The alkyl chain of the aliphatic alcohol can either be straight or branched, primary or secondary, and generally contains from about 8 to about 22 carbon atoms. Examples of such ethoxylated alcohols include the condensation product of myristyl alcohol condensed with about 10 moles of ethylene oxide per mole of alcohol and the condensation product of about 9 moles of ethylene oxide with coconut alcohol (a mixture of fatty alcohols with alkyl chains varying in length from about 10 to 14 carbon atoms). Other examples are those C₆-C₁₁ straight-chain alcohols which are ethoxylated with from about 3 to about 6 moles of ethylene oxide.

Their derivation is well known in the art. Examples include Alfonic® 810-4.5, which is described in product literature from Sasol as a C₈₋₁₀ having an average molecular weight of 356, an ethylene oxide content of about 4.85 moles (about 60 wt. %), and an HLB of about 12; Alfonic® 810-2, which is described in product literature as a C₈-C₁₀ having an average molecular weight of 242, an ethylene oxide content of about 2.1 moles (about 40 wt. %), and an HLB of about 12; and Alfonic® 610-3.5, which is described in product literature as having an average molecular weight of 276, an ethylene oxide content of about 3.1 moles (about 50 wt. %), and an HLB of 10. Other examples of alcohol ethoxylates are C₁₀ ox-alcohol ethoxylates available from BASF under the Lutensol® ON tradename. They are available in grades containing from about 3 to about 11 moles of ethylene oxide (available under the names Lutensol® ON 30; Lutensol® ON 50; Lutensol® ON 60; Lutensol® ON 65; Lutensol® ON 66; Lutensol® ON 70; Lutensol® ON 80; and Lutensol® ON 110). Other examples of ethoxylated alcohols include the Neodol® 91 series non-ionic surfactants available from Shell Chemical Company which are described as C₉-C₁₁ ethoxylated alcohols. The Neodol® 91 series non-ionic surfactants of interest include Neodol® 91-2.5, Neodol® 91-6, and Neodol® 91-8. Neodol® 91-2.5 has been described as having about 2.5 ethoxy groups per molecule; Neodol 91-6 has been described as having about 6 ethoxy groups per molecule; and Neodol 91-8 has been described as having about 8 ethoxy groups per molecule. Further examples of ethoxylated alcohols include the Rhodasurf® DA series non-ionic surfactants available from Rhodia which are described to be branched isodecyl alcohol ethoxylates. Rhodasurf® DA-530 has been described as having 4 moles of ethoxylation and an HLB of 10.5; Rhodasurf® DA-630 has been described as having 6 moles of ethoxylation with an HLB of 12.5; and Rhodasurf® DA-639 is a 90% solution of DA-630. Further examples of ethoxylated alcohols include those from Tomah Products (Milton, Wis.) under the Tomadol® tradename with the formula RO(CH₂CH₂O)ₙH where R is the primary linear alcohol and n is the total number of moles of ethylene oxide. The ethoxylated alcohol series from Tomah include 91-2.5; 91-6; 91-8- where R is linear C₉/C₁₀/C₁₁ and n is 2.5, 6, or 8.

A further class of useful nonionic surfactants include primary and secondary linear and branched alcohol ethoxylates, such as those based on C₆-C₁₈ alcohols which further include an average of from 2 to 80 moles of ethoxylation per mol of alcohol. These examples include the Genapol® UD (ex. Clariant, Muttenz, Switzerland) described under the tradenames Genapol® UD 030, C₁₁-oxo-alcohol polyglycol ether with 3 EO; Genapol® UD, 050 C₁₁-oxo-alcohol polyglycol ether with 5 EO; Genapol® UD 070, C₁₁-oxo-alcohol polyglycol ether with 7 EO; Genapol® UD 080, C₁₁-oxo-alcohol polyglycol ether with 8 EO; Genapol® UD 088, C₁₁oxo-alcohol polyglycol ether with 8 EO; and Genapol® UD 110, C₁-oxo-alcohol polyglycol ether with 11 EO. Other nonionic sulfactants suitable for use include C₂₀-C₂₂ alkyl ethoxylate with 18 to 50 ethylene oxide groups (EO). In another embodiment, C₂₀-C₂₂ alkyl ethoxylate comprise 25 to 35 ethylene oxide groups, preferably as an adhesion promoter and nonionic surfactant.

A further class of useful nonionic surfactants include those surfactants having a formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from about 1 to about 12. Surfactants of this formula are presently marketed under the Genapol® tradename (ex. Clariant), which surfactants include the “26-L” series of the general formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from 1 to about 12, all sold under the Genapol® tradename.

A further class of useful nonionic surfactants include alkoxy block copolymers, and in particular, compounds based on ethoxy/propoxy block copolymers. Polymeric alkylene oxide block copolymers include nonionic surfactants in which the major portion of the molecule is made up of block polymeric C₂-C₄ alkylene oxides. Such nonionic surfactants, while preferably built up from an alkylene oxide chain starting group, and can have as a starting nucleus almost any active hydrogen containing group including, without limitation, amides, phenols, thiols and secondary alcohols.

One group of such useful nonionic surfactants containing the characteristic alkylene oxide blocks are those which may be generally represented by the formula (1):

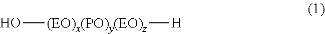

where EO represents ethylene oxide,
PO represents propylene oxide,
y equals at least 15,
(EO)_{x+y} equals 20 to 50% of the total weight of said compounds, and, the total molecular weight is preferably in the range of about 2000 to 15,000. These surfactants are available under the PLURONIC (ex. BASF) or Emulgen (ex. Kao.)

A further group of such useful nonionic surfactants containing the characteristic alkylene oxide blocks are those can be represented by the formula (2):

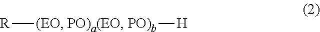

wherein R is an alkyl, aryl or aralkyl group, where the R group contains 1 to 20 carbon atoms, the weight percent of EO is within the range of 0 to 45% in one of the blocks a, b, and within the range of 60 to 100% in the other of the blocks a, b, and the total number of moles of combined EO and PO is in the range of 6 to 125 moles, with 1 to 50 moles in the PO rich block and 5 to 100 moles in the EO rich block. Specific nonionic surfactants which in general are encompassed by Formula 2 include butoxy derivatives of propylene oxide/ethylene oxide block polymers having molecular weights within the range of about 2000-5000.

Still further examples of useful nonionic surfactants include those which can be represented by formula (3) as follows:

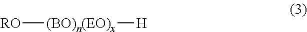

wherein EO represents ethylene oxide,
BO represents butylene oxide,
R is an alkyl group containing I to 20 carbon atoms, n is about 5-15 and x is about 5-15.

Yet further useful nonionic surfactants include those which may be represented by the following formula (4):

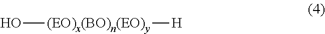

wherein EO represents ethylene oxide,
BO represents butylene oxide, n is about 5-15, preferably about 15,
x is about 5-15, preferably about 15, and
y is about 5-15, preferably about 15.

Still further exemplary useful nonionic block copolymer surfactants include ethoxylated derivatives of propoxylated ethylene diamine, which may be represented by the following formula (4):

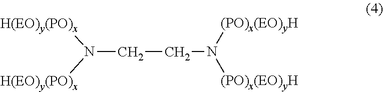

where (EO) represents ethoxy,
(PO) represents propoxy,
the amount of (PO)ₓ is such as to provide a molecular weight prior to ethoxylation of about 300 to 7500, and the amount of (EO)_{y} is such as to provide about 20% to 90% of the total weight of said compound.

Further useful non-ionic surfactants which may be used in the inventive compositions include those presently marketed under the trade name Pluronics® (ex. BASF). The compounds are formed by condensing ethylene oxide with a hydrophobic base formed by the condensation of propylene oxide with propylene glycol. The molecular weight of the hydrophobic portion of the molecule is of the order of 950 to 4,000 and preferably 200 to 2,500. The addition of polyoxyethylene radicals of the hydrophobic portion tends to increase the solubility of the molecule as a whole so as to make the surfactant water-soluble. The molecular weight of the block polymers varies from 1,000 to 15,000 and the polyethylene oxide content may comprise 20% to 80% by weight. Preferably, these surfactants are in liquid form and particularly satisfactory surfactants are available as those marketed as Pluronics® L62 and Pluronics® L64.

Alkylmonoglyocosides and alkylpolyglycosides which find use in the present inventive compositions include known nonionic surfactants which are alkaline and electrolyte stable. Alkylmonoglycosides and alkylpolyglycosides are prepared generally by reacting a monosaccharide, or a compound hydrolyzable to a monosaccharide with an alcohol such as a fatty alcohol in an acid medium. Various glycoside and polyglycoside compounds including alkoxylated glycosides and processes for malting them are disclosed in U.S. Pat. Nos. 2,974,134; 3,219,656; 3,598,865; 3,640,998; 3,707,535, 3,772,269; 3,839,318; 3,974,138; 4,223,129 and 4,528,106 the contents of which are incorporated by reference.

One exemplary group of such useful alkylpolyglycosides include those according to the formula (5):

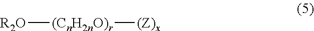

wherein:
R₂ is a hydrophobic group selected from alkyl groups, alkylphenyl groups, hydroxyalkylphenyl groups as well as mixtures thereof, wherein the alkyl groups may be straight chained or branched, and which contain from about 8 to about 18 carbon atoms,
n has a value of 2-8, especially a value of 2 or 3,
r is an integer from 0 to 10, but is preferably 0,
Z is derived from glucose; and,
x is a value from about 1 to 8, preferably from about 1.5 to 5.

Preferably the alkylpolyglycosides are nonionic fatty alkylpolyglucosides which contain a straight chain or branched chain C₈-C₁₅ alkyl group, and have an average of from about 1 to 5 glucose units per fatty alkylpolyglucoside molecule. More preferably, the nonionic fatty alkylpolyglucosides which contain straight chain or branched C₈-C₁₅ alkyl group, and have an average of from about 1 to about 2 glucose units per fatty alkylpolyglucoside molecule.

A further exemplary group of allyl glycoside surfactants suitable for use in the practice of this invention may be presented by the following formula (6):

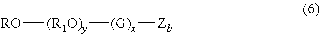

wherein:
R is a monovalent organic radical containing from about 6 to about 30, preferably from about 8 to 18 carbon atoms,
R₁ is a divalent hydrocarbon radical containing from about 2 to about 4 carbon atoms,
y is a number which has an average value from about 0 to about 1 and is preferably 0,
G is a moiety derived from a reducing saccharide containing 5 or 6 carbon atoms; and,
x is a number having an average value from about 1 to 5 (preferably from 1.1 to 2);
Z is O₂M¹,

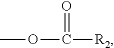

O(CH₂), CO₂M¹, OSO₃M¹, or O(CH₂)SO₃M¹;
R₂ is (CH₂)CO₂M¹ or CH═CHCO₂M¹; (with the proviso that Z can be O₂M¹ only if Z is in place of a primary hydroxyl group in which the primary hydroxyl-bearing carbon atom, —CH₂OH, is oxidized to form a

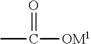

group,
b is a number of from 0 to 3x+1 preferably an average of from 0.5 to 2 per glycosal group,
p is 1 to 10,
M¹ is H⁺ or an organic or inorganic counterion, particularly cations such as, for example, an alkali metal cation, ammonium cation, monoethanolamine cation or calcium cation.

As defined in formula (6) above, R is generally the residue of a fatty alcohol having from about 8 to 30 and preferably 8 to 18 carbon atoms. Examples of such alkylglycosides as described above include, for example APG 325 CS Glycoside® which is described as being a 50% C₉-C₁₁ alkyl polyglycoside, also commonly referred to as D-glucopyranoside, (commercially available from Henkel KGaA) and Glucopon® 625 CS which is described as being a 50% C₁₀-C₁₆ alkyl polyglycoside, also commonly referred to as a D-glucopyranoside, (ex. Henkel). Still further useful nonionic surfactants include those based on tallowamine, such as PEG-2 tallowamines.

Further nonionic surfactants which may be included in the inventive compositions include alkoxylated alkanolamides, preferably C₈-C₂₄ alkyl di(C₂-C₃ alkanol amides), as represented by the following formula (7):

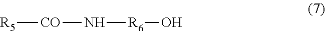

wherein R₅ is a branched or straight chain C₈-C₂₄ alkyl radical, preferably a C₁₀-C₁₆ alkyl radical and more preferably a C₁₂-C₁₄ alkyl radical, and R₆ is a C₁-C₄ alkyl radical, preferably an ethyl radical.

The inventive compositions may also include a nonionic amine oxide constituent. Exemplary amine oxides include:
(A) Alkyl di(lower alkyl) amine oxides in which the alkyl group has about 10-20, and preferably 12-16 carbon atoms, and can be straight or branched chain, saturated or unsaturated. The lower alkyl groups include between 1 and 7 carbon atoms. Examples include lauryl dimethyl amine oxide, myristyl dimethyl amine oxide, and those in which the alkyl group is a mixture of different amine oxide, dimethyl cocoamine oxide, dimethyl (hydrogenated tallow) amine oxide, and myristyl/palmityl dimethyl amine oxide;
(B) Alkyl di(hydroxy lower alkyl) amine oxides in which the alkyl group has about 10-20, and preferably 12-16 carbon atoms, and can be straight or branched chain, saturated or unsaturated. Examples are bis(2-hydroxyethyl) cocoamine oxide, bis(2-hydroxyethyl) tallowamine oxide; and bis(2-hydroxyethyl) stearylamine oxide;
(C) Alkylamidopropyl di(lower alkyl) amine oxides in which the alkyl group has about 10-20, and preferably 12-16 carbon atoms, and can be straight or branched chain, saturated or unsaturated. Examples are cocoamidopropyl dimethyl amine oxide and tallowamidopropyl dimethyl amine oxide; and
(D) Alkylmorpholine oxides in which the alkyl group has about 10-20, and preferably 12-16 carbon atoms, and can be straight or branched chain, saturated or unsaturated.

Preferably the amine oxide constituent is an alkyl di(lower alkyl) amine oxide as denoted above and which may be represented by the following structure formula (8):

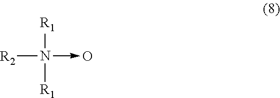

wherein each:
R₁ is a straight chained C₁-C₄ allyl group, preferably both R₁ are methyl groups; and,
R₂ is a straight chained C₈-C₁₈ alkyl group, preferably is C₁₀-C₁₄ alkyl group, most preferably is a C₁₂ alkyl group.

Each of the alkyl groups may be linear or branched, but most preferably are linear. Most preferably the amine oxide constituent is lauryl dimethyl amine oxide. Technical grade mixtures of two or more amine oxides may be used, wherein amine oxides of varying chains of the R₂ group are present. Preferably, the amine oxides used in the present invention include R₂ groups which comprise at least 50% wt., preferably at least 60% wt. of C₁₂ alkyl groups and at least 25% wt. of C₁₄ alkyl groups, with not more than 15% wt. of C₁₆, C₁₈ or higher alkyl groups as the R₂ group.

The nonionic surfactant constituent, when present, my comprise one or more nonionic surfactants. In certain preferred embodiments the inventive compositions comprise only one nonionic surfactant. When present, any nonionic surfactants present in the compositions of the present invention are desirably included in an amount of from about 0.01% wt. to about 20% wt., more preferably is present in an amount of from about 0.1%-15% wt., and most preferably is present in an amount of from about 1.5% to about 2.5% wt.

The compositions according to the invention may optionally further comprise an alkyl ethoxylated carboxylate surfactant. In particular, the alkyl ethoxylated carboxylate comprises compounds and mixtures of compounds which may be represented by the formula (9):

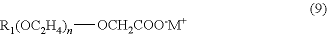

wherein R₁ is a C₄-C₁₈ alkyl, n is from about 3 to about 20, and M is hydrogen, a solubilizing metal, preferably an alkali metal such as sodium or potassium, or ammonium or lower alkanolammonium, such as triethanolammonium, monoethanolammonium, or diisopropanolammonium. The lower alkanol of such alkanolammonium will normally be of 2 to 4 carbon atoms and is preferably ethanol. Preferably, R₁ is a C₁₂-C₁₅ alkyl, n is from about 7 to about 13, and M is an alkali metal counterion.

The inventive compositions also contain a cationic surfactant compound. some of these cationic surfactant compounds may also provide a disinfecting or sanitizing benefit to the compositions of which they form a part. Other cationic surfactant compounds may act as a surfactant and/or thickening benefit to the compositions of which they form a part.

Exemplary cationic surfactants suitable for the present invention include but are not limited to sarcosinate surfactants including alkali metal salts of N-alkyl-N-acyl amino acids. These are salts derived from the reaction of (1)N-alkyl substituted amino acids of the formula (11):

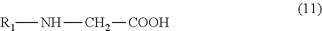

where R₁ is a linear or branched chain lower alkyl of from 1 to 4 carbon atoms, especially a methyl, for example, aminoacetic acids such as N-methylaminoacetic acid (i.e. N-methyl glycine or sarcosine), N-ethyl-aminoacetic acid, N-butylaminoacetic acid, etc., with (2) saturated natural or synthetic fatty acids having from 8 to 18 carbon atoms, especially from 10 to 14 carbon atoms, e.g. lauric acid, and the like.

Exemplary useful and preferred sarcosinate surfactants include cocoyl sarcosinate, lauroyl sarcosinate, myristoyl sarcosinate, palmitoyl sarcosinate, stearoyl sarcosinate and oleoyl sarcosinate, and tallow sarcosinate. Such materials are also referred to as N-acyl sarcosinates.

Exemplary cationic surfactant compounds which may also provide a disinfecting or sanitizing benefit to the compositions include cationic surfactant compositions which provide a germicidal effect to the compositions, and especially preferred are quaternary ammonium compounds and salts thereof, which may be characterized by the general structural formula (12):

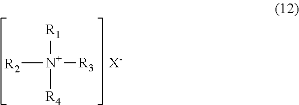

where at least one of R₁, R₂, R₃ and R₄ is a alkyl, aryl or alkylaryl substituent of from 6 to 26 carbon atoms, and the entire cation portion of the molecule has a molecular weight of at least 165. The alkyl substituents may be long-chain alkyl, long-chain alkoxyaryl, long-chain alkylaryl, halogen-substituted long-chain alkylaryl, long-chain alkylphenoxyalkyl, arylalkyl, etc. The remaining substituents on the nitrogen atoms other than the abovementioned alkyl substituents are hydrocarbons usually containing no more than 12 carbon atoms. The substituents R₁, R₂, R₃ and R₄ may be straight-chained or may be branched, but are preferably straight-chained, and may include one or more amide, ether or ester linkages. The counterion X may be any salt-forming anion which permits water solubility of the quaternary ammonium complex.

Exemplary quaternary ammonium salts within the above description include the alkyl ammonium halides such as cetyl trimethyl ammonium bromide, alkyl aryl ammonium halides such as octadecyl dimethyl benzyl ammonium bromide, N-alkyl pyridinium halides such as N-cetyl pyridinium bromide, and the like. Other suitable types of quaternary ammonium salts include those in which the molecule contains either amide, ether or ester linkages such as octyl phenoxy ethoxy ethyl dimethyl benzyl ammonium chloride, N-(laurylcocoaminoformylmethyl)-pyridinium chloride, and the like. Other very effective types of quaternary ammonium compounds which are useful as germicides include those in which the hydrophobic radical is characterized by a substituted aromatic nucleus as in the case of lauryloxyphenyltrimethyl ammonium chloride, cetylaminophenyltrimethyl ammonium methosulfate, dodecylphenyltrimethyl ammonium methosulfate, dodecylbenzyltrimethyl ammonium chloride, chlorinated dodecylbenzyltrimethyl ammonium chloride, and the like.

Preferred quaternary ammonium compounds which act as germicides and which are be found useful in the practice of the present invention include those which have the structural formula (13):

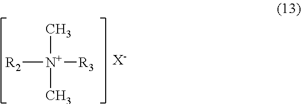

wherein R₂ and R₃ are the same or different C₈-C₁₂alkyl, or R₂ is C₁₂₋₁₆alkyl, C₈₋₁₈alkylethoxy, C₈-18alkylphenolethoxy and R₃ is benzyl, and X is a halide, for example chloride, bromide or iodide, or is a methosulfate anion. The alkyl groups recited in R₂ and R₃ may be straight-chained or branched, but are preferably substantially linear.

Particularly useful quaternary germicides include compositions which include a single quaternary compound, as well as mixtures of two or more different quaternary compounds. Such useful quaternary compounds are available under the BARDAC®, BARQUAT®, HYAMINE®, and ONYXIDE® trademarks.

Cationic surfactants which may be used in the compositions of the invention and which may provide a thickening benefit to the compositions include alkoxylated fatty amine compounds. Such alkoxylated fatty amine compounds include primary, secondary and tertiary fatty amines. Exemplary primary fatty amine compounds include for example, those which may be represented by the following structural representation: R—NH₂
wherein: R is based on a technical grade mixture of predominantly C₁₀-C₂₀ straight chained or branched alkyl groups, but preferably are predominantly C₁₆-C₁₈ straight chained or branched alkyl groups, which groups may be saturated or unsaturated.

Exemplary primary fatty amine compounds include for example, those which may be represented by the following formula (14):

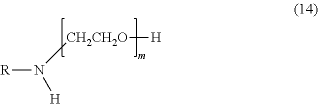

wherein: R is based on a technical grade mixture of predominantly C₁₀-C₂₀ straight chained or branched alkyl groups, but preferably are predominantly C₁₆-C₁₈ straight chained or branched alkyl groups, which groups may be saturated or unsaturated; and, m has a value of from about 2 to about 10, inclusive.

Exemplary alkoxylated fatty tertiary amines include those which may be represented by the following structural formula (15):

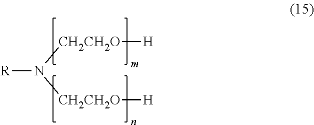

wherein R is based on a technical grade mixture of predominantly C₁₀-C₂₀ straight chained or branched alkyl groups, but preferably are predominantly C₁₆-C₁₈ straight chained or branched alkyl groups, which groups may be saturated or unsaturated; and wherein m+n=2-10, but preferably m+n=4-6.

It is to be understood that other alkoxylated fatty amines which are not represented by any of the structures indicated above may also be used in the inventive compositions, and that these structures provide examples by way of illustration but not by way of limitation. These materials are available from a variety of sources and include for example alkoxylated amines presently commercially available in the DeThox® Amine series (DeForest Enterprises, Inc.) including DeThox® Amine C-5 and DeThox® Amine C-15, both which are described to be cocoamine ethoxylates, in the Hetoxamine® series (Heterine Inc.) including Hetoxamine® T-5 described to be a PEG-5 tallowamine, Hetoxamine® T-15 described to be a POE-15 tallowamine, and Hetoxamine® described to be a POE-20 tallowamine, as well as in the Rhodameen® series (Rhone-Poulenc) but further useful alkoxylated amines may also be obtained from other commercial sources. One such further class of alkoxylated amines are PEG-tallowamines which include various grades of polyethylene glycol (PEG) polymer which are commercially available under the Aminogen® tradename. Particularly useful and most preferred are the fatty amine compounds disclosed below. These alkoxylated fatty amine surfactants may be used singly, or in combination with one another to form mixtures.

In some embodiments, the cationic surfactant may be BTC 824 P-100 (alkyl dimethyl benzyl ammonium chloride), and alkyl dimethyl benzyl ammonium chloride such as BARQUAT MS-100 (benzyl-C₁₂₋₁₄-alkyldimethylammonium chlorides). In some embodiments, the quaternary ammonium compound is selected from the group consisting of alkyldimethylbenzyl ammonium chloride, alkyldimethyl (ethylbenzyl) ammonium chloride, alkyl trimethyl ammonium chloride where alkyl group is a combination of C₁₀₋₂₀, N-alkyl, N, N-dimethyl N benzyl ammonium, and mixtures thereof. In some embodiments, the quaternary ammonium compound is a combination of C₁₂₋₁₄ alkyl [(ethyl phenyl)methyl]dimethyl, chlorides and benzyl-C₁₂₋₁₈-alkyldimethyl, chlorides. In some embodiments each of the thereof. In some embodiments, the quaternary ammonium compound is a combination of C₁₂₋₁₄ alkyl [(ethylphenyl)methyl]dimethyl, chlorides and benzyl-C₁₂₋₁₈-alkyldimethyl, chlorides each used at about 20% by weight.

Other useful compounds are available under the BARDAC®, BARQUAT®, HYAMINE®, BTC®), and ONYXIDE® trademarks, which are more fully described in, for example, Mccutcheon's Functional Materials (Vol. 2), North American Edition, 2000, and the respective product literature from the suppliers identified below. BARDAC® 205M is described to be a liquid containing alkyl dimethyl benzyl ammonium chloride, octyl decyl dimethyl ammonium chloride; didecyl dimethyl ammonium chloride, and dioctyl dimethyl ammonium chloride (50% active) (also available as 80% active (BARDAC® 208M); described generally in Mccutcheon's as a combination of alkyl dimethyl benzyl ammonium chloride and dialkyl dimethyl ammonium chloride); BARDAC® 2050 is described to be a combination of octyl decyl dimethyl ammonium chloride/didecyl dimethyl ammonium chloride, and dioctyl dimethyl ammonium chloride (50% active) (also available as 80% active (BARDAC® 2080)); BARDAC® 2250 is described to be didecyl dimethyl ammonium chloride (50% active); BARDAC® LF (or BARDAC® LF-80), described as being based on dioctyl dimethyl ammonium chloride (BARQUAT® MB-50, MX-50, OJ-50 (each 50% liquid) and MB-80 or MX-80 (each 80% liquid) are each described as an alkyl dimethyl benzyl ammonium chloride; BARDAC® 4250 and BARQUAT® 4250Z (each 50% active) or BARQUAT® 4280 and BARQUAT® 4280Z (each 80% active) are each described as alkyl dimethyl benzyl ammonium chloride/alkyl dimethyl ethyl benzyl ammonium chloride. Also, HYAMINE®) 1622, described as diisobutyl phenoxy ethoxy ethyl dimethyl benzyl ammonium chloride (50% solution); HYAMINE® 3500 (50% actives), described as alkyl dimethyl benzyl ammonium chloride (also available as 80% active (HYAMINE® 3500-80); and HYAMINE® 2389 described as being based on methyldodecylbenzyl ammonium chloride and/or methyldodecylxylene-bis-trimethyl ammonium chloride. (BARDAC®, BARQUAT®) and HYAMINE®). BTC® 50 NF (or BTC® 65 NF) is described to be alkyl dimethyl benzyl ammonium chloride (50% active); BTC® 99 is described as didecyl dimethyl ammonium chloride (50% active); BTC®) 776 is described to be myristalkonium chloride (50% active); BTC® 818 is described as being octyl decyl dimethyl ammonium chloride, didecyl dimethyl ammonium chloride, and dioctyl dimethyl ammonium chloride (50% active) (available also as 80% active (BTC®) 818-80%)); BTC® 824 and BTC® 835 are each described as being of alkyl dimethyl benzyl ammonium chloride (each 50% active); BTC®) 885 is described as a combination of BTC® 835 and BTC® 818 (50% active) (available also as 80% active (BTC® 888)); BTC® 1010 is described as didecyl dimethyl ammonium chloride (50% active) (also available as 80% active (BTC® 1010-80)); BTC® 2125 (or BTC® 2125 M) is described as alkyl dimethyl benzyl ammonium chloride and alkyl dimethyl methylbenzyls ammonium chloride (each 50% active) (also available as 80% active (BTC® 2125 80 or BTC® 2125 M)); BTC®) 2565 is described as alkyl dimethyl benzyl ammonium chlorides (50% active) (also available as 80% active (BTC® 2568)); BTC® 8248 (or BTC® 8358) is described as alkyl dimethyl benzyl ammonium chloride (80% active) (also available as 90% active (BTC® 8249)); ONYXIDE® 3300 is described as n-alkyl dimethyl benzyl ammonium saccharinate (95% active). (BTC® and ONYXIDE® are presently commercially available from Stepan Company). Polymeric quaternary ammonium salts based on these monomeric structures are also considered desirable for the present invention. One example is POLYQUAT®, described as being a 2-butenyldimethyl ammonium chloride polymer. Other cationic surfactants suitable for use in the present invention are also set forth in the Examples below.

The cationic surfactant constituent, when present, may comprise one or more cationic surfactants. In certain preferred embodiments the inventive compositions comprise only one cationic surfactant. When present, any cationic surfactants present in the compositions of the present invention are desirably included in an amount of from about 0.1% wt. to about 20% wt., more preferably is present in an amount of from about 0.5-10% wt., and most preferably is present in an amount of from about 1.0 to about 1.5% wt.

By way of non-limiting example, the surfactant system according to the present invention may also contain amphoteric surfactants such as one or more water-soluble betaine surfactants.

### Superwetting Agents

Superwetting agents or superwetters (used interchangeably) are substrate wetting agents that are highly efficient at reducing surface tension as well as contact angle. Their established multi-functional characteristic helps formulators develop high-performance formulations providing flow and leveling properties without significant impact on the desired viscosity of the cleaning compositions according to the present invention. They may at some embodiments be a part of surfactant system or they can also be present as a separate component.

The superwetting agents are selected from the group consisting of trisiloxane surfactants, gemini surfactants, ethoxylated trisiloxanes, silicone glycol copolymers, pegylated dimethicones, N-alkyl pyrrolidones, fluorosurfactants, polyether polyols, primary alcohol ethoxylates, alkylamine oxide and secondary ethoxylated alcohols. In some embodiments, the primary alcohol ethoxylates is lauryl alcohol 9-ethoxylates. In some embodiments, the alkylamine oxide is lauryl amine oxide. In some embodiments, the superwetter agent is a combination of lauryl alcohol 9-ethoxylates and lauryl amine oxide.

The addition of the superwetting agents of choice alters the base cleaning compositions properties, so that the novel superwetter-containing cleaning compositions according to the present invention are able to provide an improved coverage of the interior sidewall of a toilet bowl by limiting the falling layer of the cleaning composition to form minimal rivulets when travelling down the toilet bowl surface. In fact, such improvement in the surface area coverage is achieved without significant loss of viscosity of the cleaning composition due to the inclusion of the superwetting agent to the base composition.

The superwetting agents according to the present invention are selected from the group consisting of lauryl amine oxide, lauryl alcohol 9-ethoxylates, alkoxylated acetylenic diols (ex. Stratasurf 607, Gemini surfactants, by Stratachem, CAS No. 169117-72-0), polyalkelene glycols (ex. Tergitol L-64, by Dow, CAS No. 9003 Nov. 6), poly alkoxylates (ex. Metolat 4050, CAS no. 160875-66-1), ethoxylated trisiloxane (ex. Wacker L099 by Wacker), non-ionic fluorosurfactants (ex. short-chain telomer-based fluorosurfactant, Thetawet FS8150 by ICT), Non-ionic organic surfactant-Alkoxylated Alcohol (ex. Breakthru Vibrant, by Evonik), Silicon glycol copolymers (ex. Xiameter OFX 5211), Pegylated dimethicone (ex. Xiameter OFX 0193), Based on N-Octyl-2-Pyrrolidone (Surfadone LP-100 & Easywet 20) and based on N-Dodecyl-2-Pyrrolidone (Surfadone LP-300). Additional superwetting agents may include optimized siloxane-based or modified polyether-siloxane (ex. DYNOL™ 960 and DYNOL™ 980) that are based on siloxane chemistry with better foam control than traditional siloxane surfactants.

In some embodiments, the primary alcohol ethoxylates is lauryl alcohol 9-ethoxylates. In some embodiments, the alkylamine oxide is lauryl amine oxide. In some embodiments, the superwetter agent is a combination of lauryl alcohol 9-ethoxylates and lauryl amine oxide. In some embodiments, the superwetting agent is a combination of lauryl amine oxide in an amount between 0.25% w/w to 3% w/w and lauryl alcohol 9-ethoxylates in an amount between 0.05% w/w to 2% w/w.

Other suitable superwetting agent may include any one or combinations of fatty alcohol ethoxylate (Tergitol 15-S-9, Hydropalat 3120), non-ionic trisiloxane surfactant (Breakthru S240), silica nano-particles, organomodified polysiloxane with dipropylene glycol monomethyl ether (Hydropalat 3323), polysiloxane with polyether groups (Wacker L201), magnesium aluminosilicate (Actigel), polyhydroxy amide (Biowet 25, Biowet 75), blend of polyalkylene glycols and poly hydroxy amide (Biowet 45, Biowet 60), polyether modified polysiloxane (Borchi Gol OL 1375, Borchi Gol OL 1570, Borchi Gol 1473, Borchi Gol OL 50, Borchi GOL LA50, Borchi GOL OL17), hydrophilic polymer (Noverite 310), ethylene glycol based fluorosurfactant (Fluor N 562).

In preferred embodiment, the superwetters are present in an amount of between about 0.001-5% wt., preferably 0.01-3.5% wt., most preferably 0.1-3.0% wt. based on the total weight of the composition of which it forms a part.

### Thickening Agents

Thickeners or thickening agents are substances that can increase the viscosity of a composition, without substantially modifying the efficacy of the active ingredient within the composition. Thickeners can also increase the stability of the compositions of the present invention. In certain aspects of the present invention, the inventors have discovered that use of any thickener may not provide the suitable viscosity for the intended purposes that is desired for the presently described compositions. The viscosity of the resulting liquid composition ranges from 1000 to 3000 cP, preferably 1500 to 2500 cP at 20° C. Brookfield Viscometer Brookfield RVDV-II, Spindle No. 3, at 20 rpm.

In some embodiments, the compositions of the present invention contain a first thickening agent selected from the group consisting of a polysaccharide polymers selected from cellulose, alkyl celluloses, alkoxy celluloses, hydroxy alkyl celluloses, alkyl hydroxy alkyl celluloses, carboxy alkyl celluloses, carboxy alkyl hydroxy allyl celluloses, naturally occurring polysaccharide polymers such as xanthan gum, guar gum, locust bean gum, tragacanth gum, or derivatives thereof, polycarboxylate polymers, polyacrylamides, clays, and mixtures thereof; cellulose derivatives include methyl cellulose ethyl cellulose, hydroxymethyl cellulose hydroxy ethyl cellulose, hydroxy propyl cellulose, carboxy methyl cellulose, carboxy methyl hydroxyethyl cellulose, hydroxypropyl cellulose, hydroxy propyl methyl cellulose, ethyl hydroxyethyl cellulose and ethyl hydroxy ethyl cellulose.

In some embodiments, the thickening agent is any one or combinations of guar gum, a xanthan gum, or sodium alginate. In some embodiments, the composition can further contain a second thickening agent with the proviso that when the first thickening agent is a guar gum, a xanthan gum, or sodium alginate, the second thickening agent is not any one of such first thickening agents.

Exemplary polycarboxylate polymers thickeners have a molecular weight from about 500,000 to about 4,000,000, preferably from about 1,000,000 to about 4,000,000, with, preferably, from about 0.5% to about 4% crosslinking. Preferred polycarboxylate polymers include polyacrylate polymers including those sold under trade names Carbopol®, Acrysol® ICS-1 and Sokalan®.

In other embodiments, a thickening agent may include any suitable substance that can increase the viscosity of the resulting liquid without substantially changing its other properties, such as methyl vinyl ether/maleic anhydride copolymer, dimethyl polysiloxane, sodium starch glycolate, sodium starch phosphate ester, sodium polyacrylate, methyl cellulose, crystalline cellulose, hydroxyethyl cellulose, hydroxymethyl cellulose, hydroxypropyl cellulose, polyvinylpyrrolidone, polyvinyl alcohol (PVA), clay materials, acid derivatives, acid copolymers, urethane associate thickeners (UAT), polyether urea polyurethanes (PEUPU), polyether polyurethanes (PEPU), or an inorganic thickener such as sodium magnesium silicate, lithium magnesium sodium silicate, acrylic acid/behenic acid copolymer, calcium carbonate, calcium silicate, magnesium silicate, silica powders, various glasses, amorphous hydrated silicic acid or fumed silica, carboxyvinyl polymer or the like may be exemplified. In some embodiments, two or more of them may be used in combination at the same time.

In some embodiments, the total concentration of the thickening agents ranges from about 0.1% to about 20% weight percent. In other embodiments, the concentration of the thickener system or the thickener ranges from about 0.5% to about 15% weight. In other embodiments, the concentration of the thickening agent from 1% to about 10% by weight.

### Optional Ingredients

In some embodiments, the present composition may include one or more additional optional ingredients selected from the group consisting of dye, a fragrance, fragrance adjuvant, a chelating agent, bleaching agent, oxidizing agents, film forming materials, preservatives, bitterness flavorant, antioxidants, radical scavengers, hydrotropes, thickeners, anticorrosion agents, solvents, opacifiers, brighteners, abrasives such as silica, kaolin, talc or an absorbent. Such ingredients as described above include known art compositions, including those described in Mccutcheon's Detergents and Emulsifiers, North American Edition, 1998; Kirk-Othmer Encyclopedia of Chemical Technology, 4th Ed., Vol. 23, pp. 478-541, the contents of which are herein incorporated by reference.

Suitable dyes and pigments that may be used in this invention include, but are not limited to Sanolin Blue EHRL, Sanolin Blue NBL, Sanolin Lave Blue A liq, Sanolin Tartrazine X 90 and Sanolin Quinoline Yellow 70 (Clariant), Acid blue or red dyes, such as Acid blue 80 CI 61585 and Acid Red 52 CI 45100, or the like such as CI Direct dyes as well as FD&C approved colorants.

Suitable fragrances that may be used in this invention includes naturally derived from plant and/or animal or synthetic fragrances including but not limited to essential oils derived from herbs, flowers, trees, and other plants. Such oils include for example, rose oil or peppermint oil, sesame oil, macadamia nut oil, tea tree oil, evening primrose oil, Spanish sage oil, Spanish rosemary oil, coriander oil, thyme oil, pimento berries oil, rose oil, anise oil, balsam oil, bergamot oil, rosewood oil, cedar oil, chamomile oil, sage oil, clary sage oil, clove oil, cypress oil, eucalyptus oil, fennel oil, sea fennel oil, frankincense oil, geranium oil, ginger oil, grapefruit oil, jasmine oil, juniper oil, lavender oil, lemon oil, lemongrass oil, lime oil, mandarin oil, marjoram oil, myrrh oil, neroli oil, orange oil, patchouli oil, pepper oil, black pepper oil, petitgrain oil, pine oil, rose otto oil, rosemary oil, sandalwood oil, spearmint oil, spikenard oil, vetiver oil, wintergreen oil, or the like known to those of skill in the art. Preferred fragrances include Dynamo 20 (I.F.F) or Marine 20 TBC T11036681 (Takasago).

Generally fragrances and perfumes are complex mixtures or blends various organic compounds including, but not limited to, certain alco hols, aldehydes, ethers, aromatic compounds and varying amounts of essential oils such as from about 0 to about 85% by weight, usually from about 10 to about 70% by weight, the essential oils themselves being Volatile odiferous compounds and also functioning to aid in the dissolution of the other components of the fragrance composition. Examples of such fragrances include digeranyl Succinate, dineryl Succinate, geranyl neryl Succinate, geranyl phenylacetate, neryl phenylacetate, geranyl laurate, neryl laurate, di(b-citronellyl) maleate, dinonadol maleate, diphenoxyanol maleate, di(3.7-dimethyl-1-octanyl) succinate, di(cyclohexylethyl) maleate, diflralyl Succinate, di(phenylethyl) adipate, 7-acetyl-1,2,3,4,5,6,7,8-octahydro-1,1,6,7-tetramethyl naphthalene, ionone methyl, ionone gamma methyl, methyl cedrylone, methyl dihydrojasmonate, methyl 1,6,10-trimethyl-2.5.9-cy clododecatrien-1-yl ketone, 7-acetyl-1,1,3,4,4,6-hexamethyl tetralin, 4-acetyl-6-tertbutyl-1—, 1-dimethyl indane, para-hydroxy-phenyl-butanone, benzophenone, methyl beta-naphthylketone, 6-acetyl-1,1,2,3,3,5hexamethylindane, 5-acetyl3-isopropyl-1,1,2,6-tetramethyl indane, 1-dodecanal, 4-(4-hydroxy-4-methylpentyl)-3-cyclohexene-1-carboxaldehyde,7-hydroxy-3,7-dimethylocatanal, 10-undecen-1-al, isohexenyl cyclohexylcarboxaldehyde, formyl tricyclodecane, condensation products of hydroxycitronellal and methyl anthranilate, condensation products of hydroxycitronellal and indol, condensation products of phenyl acetaldehyde and indol, 2-methyl-3-(para-tert-butylphenyl)-propionaldehyde,ethyl Vanillin, heliotropin, hexyl cinnamic aldehyde, amylcinnamic aldehyde, 2-methyl-2-(para-iso-propylphenyl) propionaldehyde, coumarin, decalactone gamma, cyclopentadecanolide, 16-hydroxy-9-hexadecenoic acid lactone, 1.3.4.6.7.8-hexahydro-4,6,6,7,8,8-hexamethylcyclopenta-gamma2-b-enzopyrane, beta-naphthol methyl ether, ambroxane,dodecahydro-3a,6,6,9a-t-etramethylnaphtho2.1blfuran, cedrol, 5-(2,2,3-trimethylcyclopent-3-enyl)-3-methylpentan-2-ol, 2-ethyl-4-(2,2,3-trimethyl-3-cyclopenten-1-yl)-2-bute-n-1-ol, caryophyllene alcohol, tricyclodecenyl propionate, tricyclodecenyl acetate, benzyl salicylate, cedrylacetate, para-(tert-butyl)cyclohexyl acetate, essential oils,resinoids, and resins from a variety of sources including but not limited to orange oil, lemon oil, patchouli, Peru balsam, Olibanum resinoid, Styrax, labdanum resin, nutmeg, cassia oil, benzoin resin, coriander, lavandin, and lavender, phenylethyl alcohol, terpineol, linalool, linallyl acetate, geraniol, nerol, 2-(1,1-dimethylethyl)cyclohexanol acetate, benzylacetate, orange terpenes, eugenol, diethylphthalate, and combinations thereof. In the present invention, the precise composition of the fragrance is of no particular consequence so long as it may be effectively included as a constituent of the compositions, and have a pleasing fragrance. Two preferred fragrances include terpene alcohols which are effective to provide a pine-type scent, or a citrus-type scent depending upon its source and/or composition, as well as methyl salicylate.

Fragrance compositions as received from a supplier may be provided as an aqueous or organically solvated composition, and may include as a hydrotrope or emulsifier or a surfactant, in minor amount, generally not in excess of about 1.5% wt. Such fragrance compositions are quite usually proprietary blends of many different specific fragrance compounds. However, one of ordinary skill in the art, by routine experimentation, may easily determine whether such a proprietary fragrance composition is compatible in the compositions of the present invention.

Such fragrances may be added in any conventional manner, admixing to a composition, or blending with other constituents used to form a composition, in amounts which are found to be useful to enhance or impart the desired scent characteristic to the composition, and/or to cleaning compositions formed therefrom.

The compositions of the invention preferably include a film forming constituent in an effective amount. The use of film forming constituent is believed to provide for a reduction in limescale deposition on the treated hard surfaces, as it is believed that the long term buildup of limescale may be resisted or retarded on hard surfaces, viz., lavatory surfaces and lavatory appliances due to the presence of the film-forming constituent thereon. While it is preferred that the film forming constituent deposit a generally continuous film on a hard surface, it is to be understood that while the film forming constituent need be present in the present inventive compositions it is not required that any layer or film formed therefrom which is formed on the surface of a lavatory appliance, e.g., toilet bowl, be necessarily uniform either in thickness or be a continuous film providing uninterrupted surface coverage although such would be preferred. Rather it is contemplated that film forming materials useful in the present invention need not form a continuous or uniform coating, as it is only required that the film forming materials provide some extent of a surface coating to a hard surface upon which it is applied. It is to be understood that the potential for forming the film layer from a film forming composition is influenced by several factors, inter alia, the nature of the hard surface being treated, the geometry and configuration of the hard surface being treated, the fluid dynamics of the delivery and application of the liquid composition of the invention onto the hard surface, as well as the quality of the water present in the lavatory appliance.

The film-forming polymer may be present in any amount which is found effective in forming a film on a hard surface being treated. It will be understood that this such a minimum amount will vary widely, and is in part dependent upon the molecular weight of the film forming polymer utilized in a formulation, but desirably at least about 0.001% wt. should be present. More preferably the film forming polymer comprises from 0.001% wt. to 10% wt. of the compositions of which it forms a part. Examples of such film forming material are more fully described for example in U.S. Pat. Nos. 4,445,521, 4,165,367, 4,223,009, 3,954,960, 4,080,310, GB 1,331,819, the contents of which are hereby incorporated by reference in their entirety.

Film forming material useful in include polyethylene oxides or mixed polyethylene oxides-polypropylene oxides having molecular weights in excess of about 50,000 and if present, desirably having molecular weights in the range of from about 100,000 to about 8,000,000. According to particularly desirable embodiments of the invention, the film-forming constituent of the present invention is solely a water soluble polyethylene oxide. The polyvinylpyrrolidone polymers useful in the present inventive compositions exhibit a molecular weight of at least about 5,000, with a preferred molecular weight of from about 6,000-3,000,000.

High molecular weight polyethylene glycol polymers useful in the present inventive compositions exhibit a molecular weight of at least about 100, preferably exhibits a molecular weight in the range of from about 100 to about 10,000 but most preferably a molecular weight in the range of from about 2000 to about 10,000. Particularly useful high molecular weight. Polyethylene glycols are available under the tradename Carbowax® (ex. Dow) or other suppliers of high molecular weight polyethylene glycols.

The compositions according to the invention are easily produced by any of a number of known art techniques. Conveniently, a part of the water is supplied to a suitable mixing vessel further provided with a stirrer or agitator, and while stirring, the remaining constituents are added to the mixing vessel, including any final amount of water needed to provide to 100% wt. of the inventive composition. Ultimately, the compositions according to have a viscosity ranging between 1000 cPs to 3000 cPs, providing a contact angle at a flat surface ranging between 5 to 30 deg and is able to provide an uniform surface coverage of at least 60%, preferably more than 70%, most preferably more than 80% of an inclined hard surface while traveling downwards. It is thought that consumers prefer such a composition because of the high viscosity and the stain removal, minimizing the need for any manual intervention inside the toilet bowl. In certain embodiments, the surface coverage achieved is between 65% to 75%.

### Methods of Use

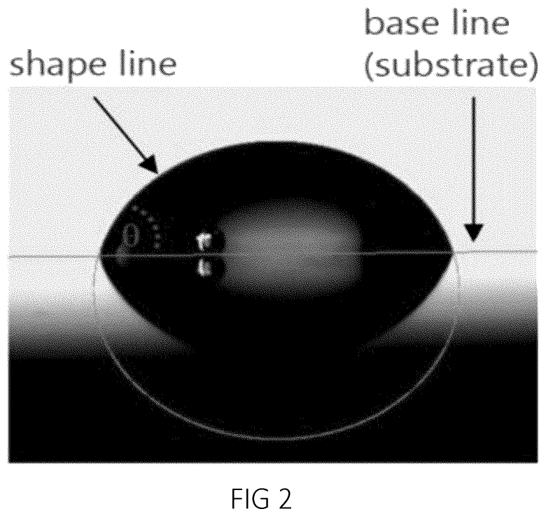

At least one aspect of the present invention is directed to optimally reducing the contact angle between the cleaning composition and the hard surfaces of interest. Contact angle is a measure of wetting of a solid by a liquid and is geometrically defined as the angle formed by liquid at the three-phase boundary where liquid, gas and solid intersect, where shape line of the droplet and the baseline of the hard surface intersect (see FIG. 2). While an understanding of the mechanism is not necessary to practice the hard surface cleaning compositions described herein, and while the present embodiments are not limited to any particular mechanism of action, it is the primary goal of the presently described compositions to form a contact angle of less than 30, less than 27, preferably less than 25, and most preferably less than 15 degrees, when the composition is applied to a hard surface. In preferred embodiments, the hard surface is of ceramic or porcelain material.

To that end, the present invention is also directed to methods of improving the performance of cleaning compositions for hard surface areas by enhancing the flow properties and viscosity of such compositions for better removal of soil and other residues. In preferred embodiments, the cleaning compositions according to the present invention are able to provide a contact angle ranging between about 5° to about 30°, preferably between 10° to 25°, thereby reducing the need to reapply the cleaning composition to cover all surfaces of interest and reduce the need to manual intervention such as using a brush by the consumers. While contact angle can be specific to the type of surface and the compositions, at least one aspect of the present invention is directed to providing cleaning compositions that provide surface contact angles of less than about 30°, 27°, 25°, 15°, or 10° after the composition is applied to a flat surface. In some embodiments, the surface is of ceramic material.

In some embodiments, the surface is rinsed after application of the cleaning composition to the surface after sufficient amount of time allowing the composition to come in contact with the stain or soils of interest to remove them from the surface. In some embodiments, the duration of contain is less than 15 minutes, less than 10 minutes, less than 5 minutes, less than 2 min, less than 1 min, less than 30 seconds, or even less than 15 seconds, before the composition is rinsed upon application of water to remove the cleaning composition from the hard surface.

The composition provided according to the invention can be desirably provided as a ready to use product in a manually operated spray-dispensing container or in a deformable “squeeze bottle’ type dispenser. With regard to the former, such are known to the art and typically comprise a flask or bottle suited for containing a quantity of the liquid composition of the invention which may be dispensed via a manually operated spray pump, while the latter is also known to the art and typically comprises a deformable bottle, typically formed of a synthetic polymer Such as polyolefin (e.g., polyethylene, polypropylene, etc.) or a polyalkylene terephthalate from which the liquid composition is expelled, typically via a nozzle, by a user compressing part of the deformable bottle. The latter provides a low cost delivery system and is particularly preferred.

In some embodiments, effective amounts of the composition according to the present invention may be applied to the inside surface of the toilet bowl (a ceramic or porcelain hard surface), then the composition is allowed to travel downwards in an inclined surface via gravity providing a surface coverage of the internal surface of the toilet of about 60% to about 99%, preferably between 65% to 85%, more preferably between 70% to 80% or most preferably about 80% coverage when applied from a container, especially a squeeze bottle onto a vertical or inclined hard surface . . .

In another example, an effective amount of the composition according to the present invention may be applied to the inside surface of a toilet bowl, under the rim, or outside of the surface of the toilet. The typical amount of the cleaning agent according to the present invention may vary depending on the type of nozzle and or the delivery bottle, but in general may range between 25 to 50 ml to circle the entire upper inside of the toilet bowl or under the rim. In yet another example, suitable amounts of the composition may be applied to the inside of a sink. The user may simply activate the faucet to provide a layer of water to the sink pipe. In still another example, an effective amount of the composition according to the present invention may be applied to the wall of a shower. The user may activate the shower to provide a liquid layer to the surface.

In some embodiments, the composition of the present invention is able to achieve a degree of germ kill allowing sufficient time for the composition to come in direct contact with the hard surfaces of interest, achieving at least a twofold reduction of the bacterial load (number of bacterial cells) of at least any three species of Enterococcus hirae, Escherichia Coli, Staphylococcus aureus and Pseudomonas aeruginosa. In some embodiments, the compositions of the present invention achieve a 4-log reduction of the bacterial load of all such species. In some embodiments, the compositions of the present invention achieve a 5-log reduction of the bacterial load of all such species as measured by appropriate EN standards tested for antimicrobial activity under European test methods such as EN 13697 and EN1276 for evaluating antimicrobial efficacy of compositions.

The present invention is also directed to a method of identifying suitable superwetting agents to be used in a cleaning composition for hard surfaces, particularly lavatory appliances and especially such surfaces and appliance surfaces which are vertical or inclined following the steps of applying the compositions of the present invention, achieving uniform down flow of the liquid composition with a contact angle ranging between about 5 to about 30° while achieving about 60% to 90% coverage of the total surface area, but at least 60%, 65%, preferably 70%, most preferably 80%, coverage, and/or achieving about 65% to 75% of the total surface area treated. The present invention is also directed to methods of identifying a surfactant system and at least one superwetting agent that reduces the contact angle of acid-based toilet bowl cleaning compositions thereby achieving maximum coverage on toilet bowl internal surfaces. To that end, superwetters may be used with a commercially available high viscous lavatory cleaning compositions to provide a novel composition providing at least 60%, 65%, 70%, 80% or preferably 90% surface coverage of a hard surface having an inclined angle.

At least one superwetting agent selected from the group consisting of lauryl amine oxide, lauryl alcohol 9-ethoxylates, alkoxylated acetylenic diols (ex. Stratasurf 607, Gemini, by Stratachem, CAS No. 169117-72-0), polyalkelene glycols (ex. Tergitol L-64, by Dow, CAS No. 9003 Nov. 6), poly alkoxylates (ex. Metolat 4050, CAS no. 160875-66-1), ethoxylated trisiloxane (ex. Wacker L099 by Wacker), non-ionic fluorosurfactants (ex. Thetawet FS8150 by ICT), Non-ionic organic surfactant (ex. Breakthru Vibrant, by Evonik), Silicon glycol copolymers (ex. Xiameter OFX 5211), Pegylated dimethicone (ex. Xiameter OFX 0193), N-Dodecyl-2-Pyrrolidones (ex. Surfadon LP-300), N-Octyl-2-Pyrrolidones (ex. Surfadon LP-100, Easywet 20), Polyether modified Polysiloxane (ex. Borchi Gol OL17) and DYNOL™ 960 and DYNOL™ 980 may be added to a base cleaning composition having a viscosity ranging between 1000 cP to 3000 cP thereby converting the base cleaning composition to a novel cleaning composition according to the present invention capable of providing a contact angle ranging between 5 to 10° with a hard ceramic surface positioned at zero degree angle. In preferred embodiment according to this aspect of the invention, the novel cleaning composition provides at least 60% to about 85% surface area coverage in inclined surfaces.

In some embodiments, the primary alcohol ethoxylates is lauryl alcohol 9-ethoxylates. In some embodiments, the alkylamine oxide is lauryl amine oxide. In some embodiments, the superwetter agent is a combination of lauryl alcohol 9-ethoxylates and lauryl amine oxide.

Illustrative and comparative examples below are intended to further demonstrate the scope of the present invention.

### Example 1-Sample Compositions According to the Present Invention

To substantiate superiority of the composition according to the present invention, Table 1 below provides four comparative examples. Comparative compositions identified as base 1 and 2 contain an amount of non-ionic and/or cationic surfactants ranging between 1.0 to 2.0% wt. as shown in the Table, to provide a cleaning composition with a viscosity ranging between 1500 to 3000 cP. The comparative examples 3 and 4 describe two prior art formulations, as exemplified and prepared in U.S. Pat. No. 7,745,384 B2

TABLE 1

| Constituent | Ingredients | Comparative 1 | Comparative 2 | Comparative 3 | Comparative 4 |
|---|---|---|---|---|---|
| Function | (Amounts in % wt.) | (Base 1) | (Base 2) | (prior art) | (prior art) |
| Non-ionic | Alkylamine Ethoxylate | 1.50-1.75 | 1.76-2.0 | | |
| Surfactant | | | | | |
| | C₁₂-C₁₄ linear alcohol ethoxylate, 1 | | | 0.25 | 0.255 |
| | moles ethoxylation | | | | |
| | (Ex. Empilan KB 10, C₁₂-C₁₄ | | | | |
| | alcohol, 10 EO) | | | | |
| Cationic | Alkyl trimethyl ammonium chloride | 1.0-1.25 | 1.26-1.5 | | |
| Surfactant | | | | | |
| | Tallow trimethyl ammonium | | | 0.947 | 0.95 |
| | chloride (50%) | | | | |
| | (Ex. Alzo Nobel, Arquad T-50) | | | | |
| | Tallowamine Surfactant | | | 1.14 | 1.60 |
| Superwetting | C₉-C₁₁ nonionic surfactant with | | | 0.10 | 0.10 |
| Agent | approx. 5.5 mols ethoxylation | | | | |
| | (Ex. Berol 266, | | | | |
| | CAS No. 68439-46-3) | | | | |
| Antioxidant | Butylated Hydroxy Toluene | 0.01923 | 0.01923 | | |
| Acidic | Hydrochloric Acid (30%) | 33.654 | 33.654 | 24.375 | 31.37 |
| component | | | | | |
| Dye | Colorant A | 0.0254 | 0.0254 | 0.22 | 0.00044 |
| Dye | Colorant B | 0.00003 | 0.00003 | 0.0062 | 0.00012 |
| Fragrance | Methyl Salicylate | 0.0733 | 0.0733 | | 0.038 |
| Solvent | Water | 63.35 | 63.06 | 73.06 | 65.95 |
| | (Deionized) | | | | |
| | TOTAL | 100 | 100 | 100 | 100 |

Table 2 below provides the test samples of compositions according to the present invention. The test samples were prepared according to conventional process known to those of ordinary skill

TABLE 2

| Constituent | Ingredients | Test | Test | Test | Test | Test | Test |
|---|---|---|---|---|---|---|---|
| Function | (Amounts in % wt.) | Sample 1 | Sample 2 | Sample 3 | Sample 4 | Sample 5 | Sample 6 |
| Non-ionic | Alkylamine Ethoxylate | 1.5-2.0 | 1.5-2.0 | 1.5-2.0 | 1.5-2.0 | 1.5-2.0 | 1.5-2.0 |
| Surfactant | | | | | | | |
| Cationic | Alkyl trimethyl | 1.0-1.5 | 1.0-1.5 | 1.0-1.5 | 1.0-1.5 | 1.0-1.5 | 1.0-1.5 |
| Surfactant | ammonium chloride | | | | | | |
| Superwetting | Polyether Polyol | | | 0.10 | | | |
| Agent | (Tergitol L-64, | | | | | | |
| | CAS No. 9003-11-6) | | | | | | |
| Superwetting | Vibrant | | | | | | 0.15 |
| Agent | | | | | | | |
| Superwetting | Metolat 4050 | | | | 0.10 | | |
| Agent | (CAS No. 160875-66-1) | | | | | | |
| Superwetting | Gemini Surfactant | | 0.15 | | | | |
| Agent | Blend of Alkoxylated | | | | | | |
| | Acetylenic Diol | | | | | | |
| | (Stratasurf 607, | | | | | | |
| | CAS No. 169117-72-0) | | | | | | |
| Superwetting | Short Chain Non Ionic | 0.8 | | | | 1.0 | |
| Agent | Fluorosurfactant | | | | | | |
| | (Thetawet FS 8150, CAS | | | | | | |
| | No. 52550-44-4) | | | | | | |
| Antioxidant | Butylated Hydroxy | 0.01923 | 0.01923 | 0.01923 | 0.01923 | 0.01923 | 0.01923 |
| | Toluene | | | | | | |
| Acidic | Hydrochloric Acid (30%) | 33.654 | 33.654 | 33.654 | 33.654 | 33.654 | 33.654 |
| component | | | | | | | |
| Dye | Colorant A | 0.0254 | 0.0254 | 0.0254 | 0.0254 | 0.0254 | 0.0254 |
| Dye | Colorant B | 0.00003 | 0.00003 | 0.00003 | 0.00003 | 0.00003 | 0.00003 |
| Fragrance | | 0.0733 | 0.0733 | 0.0733 | 0.0733 | 0.0733 | 0.0733 |
| Solvent | Water (Deionized) | 63.06 | 63.06 | 63.06 | 63.35 | 63.06 | 63.06 |
| | TOTAL | 100 | 100 | 100 | 100 | 100 | 100 |

in the art by combining the listed ingredients. These test samples contain the same base as those compositions that are mentioned in Table 1 but also include a suitable superwetter selected herein.

The cleaning performance of compositions according to the present invention as described in the Table 2 were then compared against those of the prior art compositions as described in Table 1, following the process described herein below in Example 2.

### Example 2-Methods of Evaluating Absolute Coverage and Total Increased Coverage when Comparing Test Compositions

Setup contains Toilet Bowl (WC) with a DSLR mounted on top of it using a tripod stand so that the distance of the camera from the surface of the WC is always fixed for all the experiments. The surface of the Toilet Bowl where the formulation is to be applied is cleaned and dried uniformly. Around 40g (±1g) of the control/test formulation is uniformly applied manually under the rim of the WC in a clockwise fashion in a single stroke. After the application, the formulation is allowed to flow naturally towards the water line. After the desired contact time (3 min, 5 min, 10 min, etc.), images are clicked using the DSLR camera. These images were then processed in ImageJ software to calculate the surface area covered by the control/test formulation-images were converted to a binary image (Black & White) and the number of pixels covered by white region (which represents area covered by control/test formulation) is measured using ImageJ.
Measurement of absolute coverage of original %:

$$\% Coverage = Po / Pt ,$$

Measurement of absolute coverage % test formulation:

$$\% Coverage = P 1 / Pt ,$$

Percentage increase in Coverage is then calculated using the below formula:

$$\% Increase in Coverage = ( P 1 - Po ) / Po$$

where,
P1—Number of pixels covered by Test formulation,
Po—Number of pixels covered by Control formulation,
Pt—Total Number of pixels for toilet surface rim to water line (available for coverage by product).

Table 3 compares the coverage of formulations listed in Table 1 and Table 2.

TABLE 3

| | | Quantity used for | Absolute Coverage | % Increase in |
|---|---|---|---|---|
| Formulation | Viscosity (cP)* | testing | % | Coverage |
| Comparative 1 (Base 1) | 1800-2200 | 40 g | 50-55% | |
| Comparative 2 (Base 2) | 2200-3000 | 40 g | 50-55% | |
| Comparative 3 (prior art) | 315 | 40 g | 45% | −20% |
| Comparative 4 (prior art) | 296 | 40 g | 52% | −7% |
| Test Sample 1 | 1800-2000 | 40 g | 75-82% | 25%-35% |
| (0.8% Thetawet FS- | | | | |
| 8150) | | | | |
| Test Sample 2 | 2000-2200 | 40 g | 65%-70% | 23% |
| (0.15% Stratasurf 607) | | | | |
| Test Sample 3 | 2000-2200 | 40 g | 65-70% | 20% |
| ( 0.10% Tergitol L-64) | | | | |
| Test Sample 4 | 1600-2000 | 40 g | 65-70% | 15% |
| (0.10% Metolat 4050) | | | | |

*Brookfield Viscometer Brookfield RVDV-II, Spindle No. 3, at 20 rpm, at 20° C.

### Example 3-Measuring Contact Angle

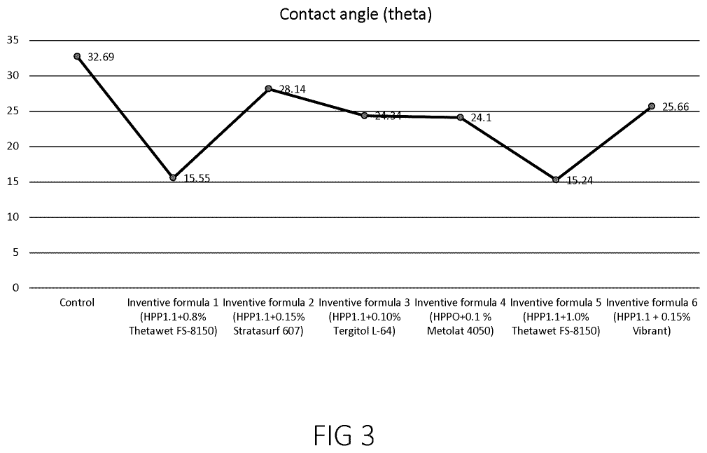

Various cleaning compositions according to the present invention were evaluated by measuring the contact angle of such composition according to Tables 1 and 2 with respect to time. Model DSA100 (Drop Shape analysis system manufactured by M/s KRUSS GmbH, Germany) was used to carry out the contact angle measurements. The ceramic tile was placed on sample platform of the instrument. A drop of the test sample was created using the dosing system of the instrument placed on tile surface. LED light source was used to illuminate the drop of sample. The 10 image of the drop was captured using a high-speed camera. The three-phase boundary is determined by the software and contours are drawn to determine the angle of contact of sample drop on solid surface. Table 4 provides a summary of the contact angle measurements for the compositions according to the present invention and the composition of Comparative 1 (also see FIG. 3).

TABLE 4

| | Contact angle |
|---|---|
| Formulation (wt %) | (theta) |
| Comparative 1 | 32.69 |
| Test Sample 1 (0.8% Thetawet FS-8150) | 15.55 |
| Test Sample 2 (0.15% Stratasurf 607) | 28.14 |
| Test Sample 3 (0.10% Tergitol L-64) | 24.34 |
| Test Sample 4 (0.1% Metolat 4050) | 24.1 |
| Test Sample 5 (1.0% Thetawet FS-8150) | 15.24 |
| Test Sample 6 ( 0.15% Vibrant) | 25.66 |

Those of ordinary skill in the art would observe from Tables that the examples according to the present invention provide lower contact angle allowing surface coverage of at least 65% of the toilet interior side walls.

### Example 4-Methods of Evaluating Rust Stain Removal from the Internal Surface of a Toilet Bowl

The following process was adapted to determine the efficacy of the compositions according to the present invention, in their removal capacity of rust stain in a toilet bowl.

a. Rust Stain Preparation:

A ferric acid solution was first prepared at the concentration of 2% ferric chloride in deionized water. Then a 1% sodium hydroxide solution was prepared by mixing 1.0 g of sodium hydroxide pellets in 99 ml of deionized water.

b. Preparing Soil Application

Prior to starting the experiments, Toilet Bowls should be cleaned and dried. Then base images of clean (unstained) toilet bowls are captured as the baseline measurement of a cleaned toilet. The surface of the toilet bowl is heated with a hot air gun set on high/hot until dry. The air gun should be held approximately 12 inches from the surface during the heating process and the toilet bowl are heated until they all reach 140°−160° F. (about 60° C. to about 70° C.). Care should be taken to allow all the surface of the Toilet Bowl to reach the same temperature. This step is repeated until the surfaces are well fully dried.

Using a fine mist sprayer, ferric chloride solution was uniformly sprayed over the entire surface of the Toilet Bowl with total of 10 sprays. The above heating steps are repeated until all the Toilet Bowl surface is dry. Using a fine mist sprayer, spray the sodium hydroxide solution uniformly over the entire surface of the Toilet Bowl with a total of 10 sprays. The above heating step are repeated until all the Toilet Bowl surface is dry.

The internal side of the toilet bowls are immediately blow dried and heated again to 140°-160° F. The stain starts out light yellow in color when initially applied, and then turns a darker rust color upon heating. Again, coat the Toilet Bowl with additional rust layer by applying 10 sprays of Ferric chloride & sodium hydroxide as described above. This process is repeated 8 times for preparing a hard rust stain. Hence, there will be total of 80 sprays each of Ferric chloride & of Sodium Hydroxide solution on to the internal surface of the bowl.

Once bowls have received 80 sprays of the rust stain each, the toilet bowl is flushed once to remove any undesired impurities. The toilet bowls are then hot dried with the hot air gun. Images of stained Toilet Bowls is then captured after the stained Toilet Bowls is completely dried.

c. Applying the Test Compositions to the Stained Toilet Bowl

Once all toilet bowls were stained according to the steps describe above, 30 grams of compositions (Test samples 1 to 3) were applied equally on all sides of the inside rim of the toilet bowls already stained. The Test compositions according to the present invention were allowed to stay 20 minutes in contact with the inside the rim surface of the toilet bowls. After 20 minutes toilet brush was used to lightly brush the surface, followed by flushing the toilets, allowing 100 ml of water to run over the covered surface sides the inside rim of the Toilet Bowl to clean the respective area. Images of cleaned Toilet Bowls should be captured after conducting cleaning.

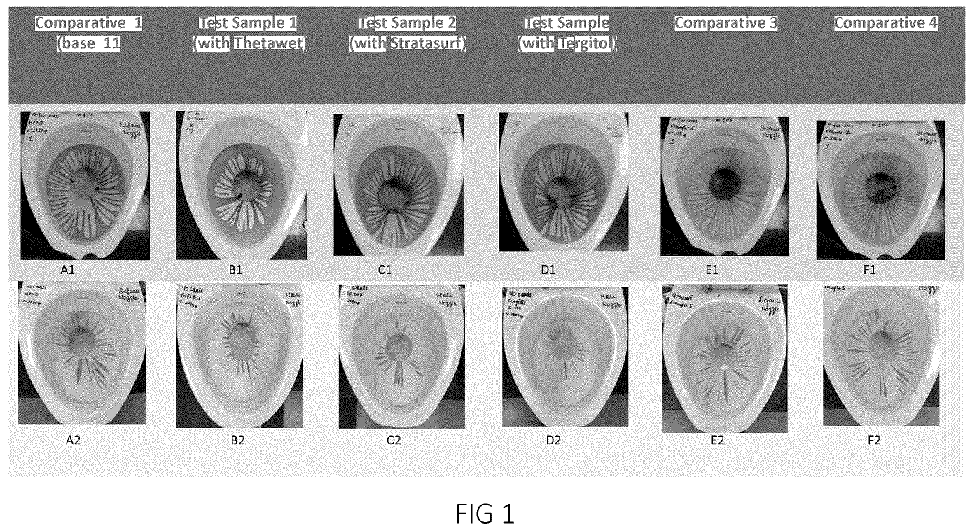

FIG. 1, A1-F2, provides a depiction of the effectiveness of the compositions according to the present invention as compared to those of prior art. The Figures clearly provide that the compositions according to the present invention can achieve at least 65% surface coverage of the toilet bowl with a dispensed product volume of not more than 50 ml when the product is applied under the rim around the top periphery of the bowl, and further remove at least 75% of stains without the use of a brush.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A hard surface cleaning composition for treatment of a sanitary appliance comprising:
a. At least one acidic source in an amount ranging between 4% to 20% weight,
b. At least one superwetting agent selected from the group consisting of trisiloxane surfactants, gemini surfactants, ethoxylated trisiloxanes, silicone glycol copolymers, pegylated dimethicones, N-alkyl pyrrolidones, non-ionic fluorosurfactants, polyether polyols, primary alcohol ethoxylates, alkylamine oxide, and secondary ethoxylated alcohols,
wherein the composition has a viscosity ranging between about 1000 cP to about 3000 cP, as measured by Brookfield Viscometer RVDV-II, Spindle No. 3, at 20 rpm, at 20° C., and the weight ratio between the acid source and the superwetting agent is 5 to 200, and wherein the composition provides a contact angle ranging between 5° to 30° on the hard flat surface laid out horizontally.

2. The composition according to claim 1, wherein the pH of the composition is less than 5, preferably less than 4.

3. The composition according to claim 1, further contains a surfactant system comprising at least one non-ionic and at least one cationic surfactant.

4. The composition according to claim 1, wherein the superwetting agent is a short-chain telomer-based fluorosurfactant (Thetawet FS-8150), modified polyether-siloxane (Dynol 980) or a gemini surfactant (Stratasurf 607).

5. The composition according to claim 1, wherein the superwetting agent is a combination of lauryl amine and lauryl alcohol 9-ethoxylates.

6. The composition according to claim 1, wherein the acid source is an organic or an inorganic acid, wherein preferably:
a. The organic acid is selected from the group consisting of:
i. linear aliphatic acids, preferably selected from the group consisting of formic acid, acetic acid, propionic acid, butyric acid and valeric acid;
ii. dicarboxylic acids, preferably selected from the group consisting of oxalic acid, malonic acid, succinic acid, glutaric acid, adipic acid, pimelic acid, fumaric acid and maleic acid;
iii. acidic amino acids, preferably selected from the group consisting of glutamic acid and aspartic acid;
iv. hydroxy acids, preferably selected from the group consisting of glycolic acid, lactic acid, hydroxyacrylic acid, alpha-hydroxybutyric acid, glyceric acid, tartronic acid, malic acid, tartaric acid and citric acid; and
v. the acid salts thereof; and any combinations thereof; and/or
b. The inorganic acid is selected from the group consisting of hydrochloric acid, sulfuric acid, phosphoric acid, potassium dihydrogenphosphate, sodium dihydrogenphosphate, sodium sulfite, potassium sulfite, sodium pyrosulfite (sodium metabisulfite), potassium pyrosulfite (potassium metabisulfite), acid sodium hexametaphosphate, acid potassium hexametaphosphate, acid sodium pyrophosphate, acid potassium pyrophosphate, sulfamic acid, and salts thereof, and any combinations thereof, preferably hydrochloric acid sulfuric acid.

7. The composition according to claim 1, wherein the acid is hydrochloric acid.

8. The composition according to claim 1, further comprising a dye, a fragrance, an anti-oxidant, a biocide, a solvent, a thickener, a film forming polymer or any mixture thereof.

9. The composition according to claim 1, wherein the at least one superwetting agent is present in concentrations ranging between 0.001 wt. % and about 5 wt. %, preferably ranging between 0.01 wt. % and 3.5 wt. %, and more preferably ranging between 0.1 wt. % and 3 wt. %.

10. The composition according to claim 1, wherein the composition provides surface area coverage on a toilet bowl of at least 65% with a dispensed product volume of not more than 50 ml when the product is applied uniformly under the rim around the top periphery of the bowl.

11. The composition according to claim 1, wherein the composition is a toilet cleaning composition.

12. The composition, according to claim 1, wherein the composition preferably provides a contact angle ranging between 5° to 25° on the hard flat surface laid out horizontally.

13. A method of cleaning a hard surface of a sanitary appliance comprising:
a. contacting the surface with the hard surface cleaning composition according to any of the prior claims,
b. achieving at least 65% surface coverage of the toilet bowl with a dispensed product volume of not more than 50 ml when the product is applied under the rim around the top periphery of the bowl,
c. allowing at least 1 minute of contact time, but no longer than 15 minutes with the hard surface,
d. applying water to rinse the hard surface,
wherein the method removes at least 75% of stains without the use of a brush.

14. The method according to claim 12, wherein the method removes at least 50% of all stains.

15. The method according to claim 13, wherein the hard surface is ceramic or porcelain.

16. A method of identifying a suitable superwetting agent for use in a hard surface cleaning composition comprising the steps of (a) choosing a hard surface cleaning composition having a viscosity of at least 1000 cP as measured by Brookfield Viscometer RVDV-II, Spindle No. 3, at 20 rpm, at 20° C., (b) applying the cleaning composition to a hard surface, (c) measuring the contact angle between the cleaning composition and the hard surface, (d) adding a candidate superwetting agent to said cleaning composition, (e) repeating steps a-d, wherein the candidate superwetting agent ingredient achieves at least a 20% reduction in contact angle of step (c), preferably wherein the contact angle is in the range of 5° to about 30°.

17. The method according to claim 16, wherein the reduction in contact angle is by at least 20% to 50%.

18. The method according to any of claim 15, wherein the hard surface is ceramic or porcelain.

19. A method of increasing surface coverage of a hard surface cleaning composition in an inclined toilet bowl, comprising the steps of (a) choosing a hard surface cleaning composition having a viscosity of at least 1000 cP as measured by Brookfield Viscometer RVDV-II, Spindle No. 3, at 20 rpm, 20° C., (b) applying the cleaning composition to a cover a hard surface, (c) adding a candidate superwetter to said cleaning composition, (d) repeating steps a-c wherein the candidate superwetter achieves at least a 15% increase in the surface coverage compared to that of step (b).

20. The method according to claim 19, wherein the increase in covered surface area is by at least 20%.

21. The method according to claim 19, wherein the candidate superwetter is selected from the group consisting of alkoxylated acetylenic diols, polyalkelene glycols, poly alkoxylates, ethoxylated trisiloxane, non-ionic fluorosurfactants, Non-ionic organic surfactant, Silicon glycol copolymers, Pegylated dimethicone, N-Dodecyl-2-Pyrrolidones, N-Octyl-2-Pyrrolidones, Polyether modified Polysiloxane and any combination thereof.

22. The method according to any of claim 19, wherein the hard surface is ceramic or porcelain.
